(19) United States
(12) Patent Application Publication
(10) Pub. No.: US 2012/0266864 A1
(43) Pub. Date: Oct. 25, 2012

(54) SOLAR HEATING AND PASTEURISATION SYSTEM

(76) Inventor: Alan Derek Wright, Norwich (GB)

(21) Appl. No.: 13/508,677

(22) PCT Filed: Nov. 8, 2010
(86) PCT No.: PCT/EP2010/006781

§ 371 Date: May 8, 2012

(30) Foreign Application Priority Data
Nov. 10, 2009 (GB) 0919602.3
Dec. 17, 2009 (GB) 0922027.8
Dec. 17, 2009 (GB) 0922034.4
Dec. 17, 2009 (GB) 0922036.9
Jan. 26, 2010 (GB) 1001186.4

(51) Int. Cl. F24J 2/04; F24J 2/00; C02F 1/02; F24J 2/40

(52) U.S. Cl. 126/585; 126/634; 126/640; 126/714; 210/149

(57) ABSTRACT

A solar water heating arrangement comprising a solar water heating element and a hot water storage vessel having a heat insulated internal volume for storage of hot water for use by a user and conduits linking them to form a fluid circulation loop is improved by providing a further, intermediate storage tank linked to the solar water heating arrangement to form another fluid circulation loop whereby the flow of fluid from the solar water heating element to the hot water storage vessel and the intermediate storage tank through the respective fluid circulation loops may be controlled for enhanced heat capture efficiency and heat storage management.

### FIELD OF THE INVENTION

This invention relates to the field of fluid heating systems and pasteurisation systems using energy from the sun. In particular, it relates to a method and apparatus for pasteurising water or other liquids in need thereof and to methods and apparatus for heating of fluids such as water, especially in domestic hot water systems.

### BACKGROUND OF THE INVENTION

Pasteurisation of sewerage or other grey water and food products, such as milk, is a common practise, especially in developed countries, as a method of killing pathogens and making said water or food products safe for human consumption. However, the pasteurisation process is often more expensive than other water treatment processes because of the energy costs of heating water.

Pasteurisation has previously found application in sewerage treatment because bio-digesters produce ‘free’ heat that can be used in the pasteurisation process. Pasteurisation is used in some food products, such as milk, due to the requirement to kill pathogens and make the milk safe for human consumption whilst having a minimal impact on the taste and pasteurisation achieves this.

In order to make water safe, it is well known that pathogens have to be killed. To be on the safe side, it is quite common to boil the water, but this does has some disadvantages, namely that boiling of some pathogen cells can release toxins into the water which is wasteful since the temperature that the water needs to reach to result in pathogen kill is significantly lower than boiling point. In particular, it is known that the temperature for killing certain pathogens is as follows:

Worms, protozoa 55° C. (1 minute for 90% kill)

E. coli, salmonella 60° C. (1 minute for 90% kill)

Hepatitis A virus 65° C. (1 minute for 90% kill)

Legionella 72° C. (instant kill)

Water treatment is a particular challenge in developing countries, where there may be shortages of water and widespread consumption of untreated water leading to disease. Energy for heating of water may not be readily available.

The use of solar energy for treatment of grey water or sewerage is a means by which water can be treated in developing and developed countries alike. Several solar energy water treatments systems have been proposed.

Safe Water Systems of Hawaii produce two solar water pasteurisation systems, which they call Sun Ray™ 30 and Sun Ray™ 1000 (described at www.safewatersystems.com). The former is a low-tech system comprising a series of 0.75 litre volume containers, which are placed in a unit having a transparent cover for receiving sunlight. It is a batch system in which the containers are filled with untreated water, placed in the unit in the sunlight. An indicator shows when the pasteurisation temperature of 62° C. is reached. The latter, the Sun Ray™ 1000, comprises a column attached to a plurality of laterally arranged evacuated glass solar collector tubes. An inlet is provided at the bottom of an inclined column to provide gravity fed water from an elevated tank or other pressurised source in order to fill the device. The head of the column is provided with a heat-actuated valve whereby when the temperature of the water reaches a certain pre-determined temperature, e.g. 65° C., the valve will open and the heated, pasteurised water transfers to a storage tank (which also acts as a heat exchanger to pre-heat the untreated water being provided to the inlet). Pasteurised water may then be drawn from the storage tank when required. A disadvantage with this system is that the solar heat collector is relatively complex comprising many parts to be assembled and which are risk of damage. In particular, in first filling with water, should cold water be placed in hot tubes, there is a risk of shattering the tubes.

US-A-2007/0193872 discloses a solar heating, distilling and pasteurisation system. The system comprises a central column with a plurality of laterally arranged evacuated glass solar collector tubes in fluid connection with the central column. Water to be treated is fed to the base of the inclined column from an associated cistern which has several settings set to release water to the column inlet in order to utilise the solar heating system either as a pasteurisation device or as a distillation device. As a distillation device, the cistern is set to a level to part fill the solar collector whereby water and water vapour are heated until it passes an outlet at the top of the column and condenses in a collector. As a pasteurisation device, the solar collector is filled with water to be treated and heated. The system is set up so that as the water is heated it expands causing water to flow over the outlet, whereby the water will be at a pasteurisation temperature when it flows over the outlet. As a pasteurisation device, this system suffers from the disadvantage of being rather inefficient. Some water that has been heated beyond the pasteurisation temperature would it appears remain inside the solar collector. More particularly, evacuated glass solar capture elements described are unlikely to be sufficiently robust and subject to shatter.

DE-A-3805557 discloses a method for pasteurising milk which comprises an insulated container of water in fluid communication with a solar energy collection panel for containing water to be heated. Heated water (heated in the solar energy collector) is provided to the insulated container. Milk to be pasteurised is then passed through a coiled heat conducting pipe positioned within the insulated container of heated water. The exit to the coiled pipe is marked by a valve which it would appear is actuated by a thermostat positioned within the insulated container and in contact with the coiled pipe whereby milk is only allowed to pass the valve when it has reached a pre-determined temperature such as a selected pasteurisation temperature at which point the valve opens until the thermostat measures a temperature below the set temperature. A second embodiment is a batch system for pasteurising milk in which a pasteurising cavity is provided within the insulated container. This may contain unpasteurised milk which is then heated by the solar heated water. The milk is mixed to ensure even heating and when a temperature of the milk reaches a desired temperature, the exit valve from the pasteurising cavity may be released (manually) to allow dispensing of the pasteurised milk. There are several disadvantages associated with this system, for example: the valve is positioned outside the insulated container, whilst thermostat is inside container and hence it can't be certain that at least the initial portion of milk has reached a pasteurisation temperature. There are also inefficiencies associated with heat exchange between water and the milk. There is no disclosure as to how solar heat may be most efficiently captured by the water and transferred to the milk.

Generally, the prior art efforts at solar pasteurisation suffer from a number of disadvantages including: use of fragile materials unsuitable for robust working conditions; indirect heating of the fluid to be pasteurised leading to inefficiency associated with heat exchange; excessive weight of materials; and lack of flexibility in sizing and productivity of system to deal with variable weather condition.

Generation of heat and electricity for domestic, commercial and industrial purposes is an increasingly pertinent challenge. Various renewable energy technologies are being developed with a view to meet that challenge. Among these technologies, solar thermal is recognized as a means of capturing solar energy for use in primarily the heating of water for local and domestic use. There are generally two types of solar water heating systems—direct and indirect heat. The first involves directly heating the water to be used and may be achieved by passing water through a panel and storing the heated water in a tank for use. This method is more commonly used in hot countries. The second involves coupling a solar heating system with a domestic water heating system by heating a fluid in a solar panel and circulating it through a heat exchange loop provided in a domestic hot water cylinder.

A disadvantage of the indirect integrated systems is that they involve a heat-exchange step, which by its nature is less efficient. Secondly, in order to capture and transfer heat effectively, it is not unusual to utilize high temperatures and pressures which requires robust high performance materials and rigorous manufacturing processes, which leads to a heavy and expensive system. Furthermore, the integration with existing heating systems requires a new dual loop hot water cylinder.

Direct and indirect solar water heating systems suffer from a disadvantage that heat is often only captured when high intensity sunlight is available which may not coincide with demand for hot water. Thus the practical capture and use in many systems is very inefficient.

### PROBLEM TO BE SOLVED BY THE INVENTION

There is a need for improvement in solar heating of fluids, particularly water and apparatus and systems therefore, which overcome the aforementioned problems and allow efficient management of solar energy capture, integration into a water heating system.

There also remains a need for improvement in solar pasteurization methods and apparatus which addresses one or more of the aforementioned problems.

### SUMMARY OF THE INVENTION

In accordance with a first aspect of the invention, there is provided a solar fluid heating system comprising

a solar energy capture element having an internal volume for containing a fluid to be heated, an element fluid inlet and an element fluid outlet;

an intermediate fluid storage tank configured for fluid communication with the element fluid inlet and the element fluid outlet of the solar heat capture element;

a fluid supply feed to the intermediate storage tank;

an inlet feed line for providing fluid to the element fluid inlet of the solar energy capture element from the intermediate fluid storage tank;

an outlet feed line for feeding fluid from the element fluid outlet of the solar energy capture element to the intermediate fluid storage tank and to an outlet draw line through which heated fluid may be drawn; and

an outlet regulator associated with the outlet draw line, said outlet regulator being responsive to temperature whereby fluid may pass the outlet regulator from the solar energy capture element through the outlet draw line when a desired temperature or relative temperature of fluid at the outlet draw line is reached.

In a second aspect of the invention, there is provided a solar water heating arrangement comprising a solar water heating system as defined above and further comprising a hot water storage vessel, the hot water storage vessel comprising a heat insulated internal volume for storage of hot water for use on-demand by a user, a demand outlet for the drawing of water from the hot water storage vessel by the user, a vessel inlet for receiving solar heated water from the outlet draw line of the solar water heating system, and a vessel conduit for transfer of water from the hot water storage vessel to the solar water heating system, the solar water heating arrangement configured such that, in use, when the temperature of water in the hot water storage vessel is lower than or a predetermined increment lower than the temperature at or associated with the outlet regulator of the solar water heating system, water from the outlet feed line will be fed into the hot water storage vessel via the vessel inlet and water from the hot water storage vessel will be fed via the vessel conduit to the solar water heating system.

In a third aspect of the invention, there is provided a solar fluid heating arrangement for space heating, the arrangement comprising

a solar energy capture element having an internal volume for containing a fluid to be heated, an element fluid inlet and an element fluid outlet;

an intermediate fluid storage tank configured for fluid communication with the element fluid inlet and the element fluid outlet of the solar heat capture element;

an inlet feed line for providing fluid to the element fluid inlet of the solar energy capture element from the intermediate fluid storage tank;

an outlet feed line for feeding fluid from the element fluid outlet of the solar energy capture element to the intermediate fluid storage tank; and

coupled with the intermediate fluid storage tank and/or the solar heat capture element a fluid-carrying space heating circuit

the arrangement configured such that when the temperature of the fluid in the intermediate fluid storage tank and/or the solar heat capture element is greater than or is greater than by a predetermined increment the temperature of the space in which the space heating circuit is configured to heat, the fluid is caused to circulate through the space heating circuit thereby providing space heating.

In a fourth aspect of the invention, there is provided a solar water heating arrangement comprising

a solar energy capture element having an internal volume for containing water to be heated, an element fluid inlet and an element fluid outlet;

a hot water storage vessel comprising a heat insulated internal volume for storage of hot water, a demand outlet for the drawing of water from the hot water storage vessel by the user, a vessel inlet and a vessel outlet;

an intermediate water storage tank having at least one fluid inlet, at least one fluid outlet;

a water supply feed for supplying water to the intermediate storage tank; and

fluid flow conduits arranged therebetween to enable

a first fluid circulation loop whereby water may circulate about a loop from the solar energy capture element to the intermediate storage tank and back to the solar energy capture element;

a second fluid circulation loop whereby water may circulate about a loop from the solar energy capture element to the hot water storage vessel and back to the solar energy capture element;

a third fluid flow arrangement or loop whereby when water is drawn from the hot water storage vessel, it may be displaced by a flow of water from the intermediate storage tank, which flow of water from the intermediate storage tank may displaced by a flow of water from a water supply inlet,
whereby the respective flow of water about the first, second and third fluid flow loops is dependent upon the respective temperatures or relative temperatures of water in each of one or more locations within the solar energy capture element, hot water storage vessel and intermediate fluid storage and/or in one or more of the fluid conduits at pre-determined locations therebetween.

In a fifth aspect of the invention, there is provided an apparatus and method for the capture, control, management and/or storage of heat in a fluid from a heat source, the method comprising

providing a heat source, a heated fluid storage tank from which heated water may be drawn and an intermediate storage tank provided with an inlet supply of fluid;

providing at least two fluid circulation loops, a first fluid circulation loop configured for fluid to flow from the heat source to the intermediate storage tank and back to the heat source and a second fluid circulation loop configured for flow from the heat source to the heated fluid storage tank and back to the heat source; and

causing the fluid to flow about the first and/or second fluid circulation loops according to certain criteria, preferably for optimum heat capture and/or storage efficiency.

Preferably the heat source according to the fifth aspect is a solar heat capture element.

In a sixth aspect of the invention, there is provided a two tank water heating arrangement comprising a first storage tank (e.g. a hot water storage vessel) for the supply of hot water on demand to a user, a second storage tank (e.g. an intermediate storage tank), in fluid communication with the first storage tank, the first and second storage tanks provided with a feed line configured to draw hot water from the level upper portion of water in the second storage tank and convey it to the bottom of the first storage tank; the arrangement further comprising an inlet from a source of heated water capable of supplying water to each of the first and second storage tanks, the inlet configured to supply heated water to the upper portion of the first storage tank or the upper portion of the second storage tank dependent upon the relative temperatures of the water in each storage tank and of the incoming heated water; the second tank having a cold water inlet.

In a seventh aspect of the invention, there is provided a continuous fluid pasteurization system comprising a solar fluid heating system as defined above and a pasteurized fluid feed line linked to the outlet draw line through which fluid may be drawn, wherein the outlet regulator allows fluid to pass the outlet draw line only when the fluid reaches or exceeds a pre-determined pasteurization temperature.

In a eighth aspect of the invention, there is provided a solar energy capture element for the capture of solar energy in a fluid to produce a fluid at a raised temperature, the element comprising

a front solar radiation receiving surface;

a back surface

an internal volume or fluid space between the front and back surfaces having a depth defined by the thickness of an edge;

two side edges;

an upper edge (upper being defined by its relative position in use)

a lower edge, the direction from the lower edge to the upper edge defining a longitudinal direction;

a plurality of longitudinal conduits arranged in a longitudinal direction

a first cross-conduit traversing the plurality of longitudinal conduits in an upper portion of the element

a second cross-conduit traversing the plurality of longitudinal conduits in a lower portion of the element,

a fluid inlet for receiving fluid to be heated into the element;

a fluid outlet for dispensing heated fluid from the element, the fluid outlet being positioned in an upper portion of the element; and, optionally,

a vapour vent to allow the release of air or fluid vapour, the vapour vent emanating from the element at a position in the upper edge or between the fluid outlet and the upper edge.

### ADVANTAGES OF THE INVENTION

The solar water/fluid heating systems and arrangements of the present invention provide increased efficiency solar water/fluid heating for use, for example, in domestic or in commercial or industrial water heating systems and in solar water pasteurization. The solar fluid heating systems are configured to provide the hottest water created for use in domestic water heating systems or for pasteurization of water for drinking thereby providing at least a small volume of hot water as it is produced rather than a large volume of tepid water or a small volume of pasteurized water as it is produced rather than a large volume of warmed unpasteurized water. Further, the system provides a means for enhancing the efficiency of solar fluid/water heating by the use of an intermediate or slave tank.

Further, the pasteurization apparatus of the present invention provides an efficient, readily deployable, micro-manageable direct solar water/fluid heating system which enables water or other fluid to be pasteurized at a pre-selected and variable pasteurization temperature without unnecessary loss of energy due to over-heating of the fluid.

### BRIEF DESCRIPTION OF THE DRAWINGS

FIG. 1 illustrates a solar fluid heating system of one aspect of the invention.

FIG. 2 illustrates a solar water heating arrangement according to one aspect of the invention.

FIG. 3 illustrates the control signal network for a system or arrangement of FIG. 1 or FIG. 2 according to another aspect of the invention.

FIG. 4 shows a preferred solar water heating arrangement of the invention.

FIG. 5 shows an alternative arrangement for feeding fluid from the solar energy capture element in system of the invention;

FIG. 6 shows a further alternative embodiment of the invention

FIG. 7 illustrates a solar water heating arrangement according to one embodiment of the invention;

FIG. 8 illustrates a solar water pasteurization system according to one aspect of the invention.

FIG. 9 illustrates a solar water pasteurization system according to a preferred aspect of the invention.

FIG. 10 illustrates a heat recovery arrangement of a pasteurisation system of the invention.

FIG. 11 illustrates a pasteurization system applied to a shower.

FIG. 12 shows an example of a solar heat capture element for use in the invention;

FIG. 13 shows one embodiment of the solar heat capture element of the invention.

FIG. 14 shows another embodiment of the solar heat capture element of the invention.

FIG. 15 shows a modular solar heat capture assembly.

FIG. 16 shows an embodiment of the solar heat capture element of the invention.

FIG. 17 shows another modular solar heat capture assembly.

FIG. 18 shows a preferred embodiment of the solar heat capture element of the invention.

FIG. 19 illustrates a preferred solar panel arrangement.

### DETAILED DESCRIPTION OF THE INVENTION

The invention in its main aspect is a solar fluid heating system for heating a fluid, such as water, for a variety of purposes. The system comprises a solar energy capture element having an internal volume for containing a fluid to be heated, an element fluid inlet and an element fluid outlet, an intermediate fluid storage tank (interchangeably referred to herein as a slave tank, depending upon the context) configured for fluid communication with the element fluid inlet and the element fluid outlet of the solar heat capture element, a fluid supply feed to the intermediate storage tank, an inlet feed line for providing fluid to the element fluid inlet of the solar energy capture element from the intermediate fluid storage tank, an outlet feed line for feeding fluid from the element fluid outlet of the solar energy capture element to the intermediate fluid storage tank and to an outlet draw line through which heated fluid may be drawn; and an outlet regulator associated with the outlet draw line, said outlet regulator being responsive to a physical parameter such as temperature whereby fluid may pass the outlet regulator from the solar energy capture element through the outlet draw line when a desired parameter, such as temperature or relative temperature of fluid at the outlet draw line is reached.

The fluid heating system according to the invention allows a fluid heated in a solar energy capture element to be fed through a draw line for collection or use elsewhere or to be fed into an intermediate or slave tank, according to pre-determined temperature requirements. For example, the system may be configured such that the fluid in the solar energy capture element is not provided to the outlet draw line until it reaches a pre-determined temperature or relative temperature at which point it may be drawn from the outlet draw line or, if not drawn from the outlet draw line fed to the slave tank if, for example, the fluid is hotter than the coolest fluid in the slave tank. The use of a slave tank allows heat captured by the fluid that is not immediately useable by being drawn through the outlet draw line to be stored in fluid in an intermediate tank. This partially heated fluid can be used, for example, to supply the solar energy capture element with partially heated fluid for periods when immediate export requirement (i.e. opportunity to draw fluid from the outlet draw line) is higher and the demand can be met more quickly and also, perhaps, when the solar energy available is lower. By the use of a slave tank in this manner, a highly efficient capture of solar energy can be achieved whilst supplying (through the outlet draw line) fluid at a required temperature as it is produced. The heat capture element is thus able to harvest solar radiance from early morning to late afternoon or early evening, even in higher latitude regions, with the flow to the solar capture element often ‘starved’ (or controlled) to encourage relatively higher temperatures of water to be produced than would be achieved if larger volumes of water were sent to the heat capture element.

The fluid may be driven from the intermediate tank to the solar heat capture element and back to the intermediate storage tank or via an outlet draw line according to any suitable means, e.g. where possible making use of thermal siphoning, pressure from dissolution of gas or gravitational head. Preferably, however, the fluid is driven by one or more pumps, preferably a plurality of pumps working in concert.

The management of fluid flow (and thereby heat capture, storage and utilization) is preferably achieved through the use of one or more temperature sensors at key positions in the system, wherein regulators and/or pumps for allowing/driving the flow of fluid about the system are responsive to temperatures at particular sensors or relative temperatures between two or more sensors.

For example, a first temperature sensor may be incorporated associated with fluid in or exiting the solar heat capture element (e.g. by positioning the first sensor in the solar heat capture element or by the element fluid outlet or in the outlet feed line) and the first temperature sensor regulating the flow of fluid (e.g. by means of one or more pumps associated with fluid flow into and/or out of the solar heat capture element and/or the outlet draw line or by means a regulator or valve, which means are responsive to the temperature of the first temperature sensor).

Preferably, a first temperature sensor is associated with the fluid near the element outlet in the solar heat capture element and a second temperature sensor is associated with the fluid in the intermediate storage tank and more preferably, fluid in the element is allowed and/or caused to feed into the intermediate storage tank when the temperature indicated by the first temperature sensor exceeds or exceeds by a pre-determined increment the temperature indicated by the second temperature sensor. This is preferably achieved by linking the two temperature sensors via a controller to one or more appropriately configured pumps and/or regulators.

The system preferably comprises a controller for controlling the respective responses of any pumps and/or regulators or valves in respect of any one or combination of temperature (or other physical property) sensors provided.

In another embodiment, the flow of fluid may be arranged as between an outlet draw line (e.g. to a heated fluid storage tank or other use) and an intermediate storage tank by a hydraulic arrangement, whereby fluid flows firstly by hydraulic priority to an outlet to the highest priority use of the heated fluid (e.g. to a heated fluid storage tank) which outlet is fitted with a pump or valve (preferably of greater size than the pump which pumps fluid through the solar energy capture element) which is preferably temperature sensor actuated whereby if the temperature is in accordance with a pre-determined desired temperature for that first priority use, the heated fluid is pumped (or allowed to flow) through the outlet to the highest priority. If the temperature is not of a pre-determined desired temperature, the fluid then flows to a second outlet to the second highest priority use of the heated fluid (e.g. to a space heating system), which second outlet is configured similarly to the first, and so on. Finally, a lowest priority outlet (typically the intermediate storage tank) captures any fluid not diverted by pumps and/or valves and hydraulic priority to other outlets, which lowest priority outlet is optionally provided with no valve or pump or with a valve or pump operable at pre-determined conditions. The order of priority is typically the order of most importance or the order of highest to lowest heat requirement and in most cases the highest priority outlet will be to a heated fluid storage vessel and can be established by the arrangement of successive sump pipes connected to respective outlets.

The solar fluid heating system may find utility in a broad spectrum of applications and are included within the scope. For example, the heating of water for industrial, commercial or domestic purposes, the heating of water or other fluid for use in space heating and for the pasteurization of water or liquid foodstuff.

Preferably, the solar heating system is for the heating of water, i.e. it is a solar water heating system.

The solar fluid/water heating system of the invention may be used with any solar energy capture element, which may comprise any arrangement of capturing solar energy in a fluid or in water. Preferably, the solar energy capture element is capable of directly capturing solar energy in the fluid (e.g. water) that is to be heated (as opposed to capturing the energy in one fluid for use in heat exchange, e.g. via a heat exchange coil, with another fluid to be heated). It is believed that direct heating of the fluid to be utilized is more efficient than indirectly heating a fluid via heat exchange with a solar heated fluid.

Preferred solar energy capture elements for use with the invention are discussed in more detail below. However, in general, it is preferred that the system is provided with an air/steam vent and/or the solar energy capture element is provided with an air/steam vent whereby the system is operable at atmospheric pressure and preferably the solar energy capture element is freely vented to atmosphere and thus is an unpressurised element in operation.

It is preferred that the fluid is water, in which case where the system or preferably the element is freely vented to atmosphere, the operating temperature of the system and/or of the solar energy capture element is a maximum of in the region of 100° C. It is a particular feature of a preferred arrangement of the present invention, that it is operable at a maximum of about the phase-transition temperature of the fluid being handled, e.g. at about 100° C. for water and in any case it is preferred that the operating temperature of the solar heat capture element and/or solar fluid heating system of the invention is up to 110° C., more preferably up to 105° C. and most preferably up to about 100° C. By having a maximum operating temperature of the element and the system of 100° C., it is possible to utilize low cost and lightweight materials capable of handling the temperatures of operation, both for the solar heat capture element and a panel in which it may be arranged and the intermediate tank as well as ancillary materials such as pipes, tubing and connectors (i.e. it is not required to use materials that are capable of handling significantly higher temperatures). Furthermore, by providing a vent in the system, the system is unpressurised hence it is possible (and a preferred embodiment of the invention) to utilize low cost and lightweight materials (e.g. that may not be capable of operating as a pressurized system). Accordingly materials such as plastic (e.g. polycarbonate) or glass (e.g. for the solar heat capture element), HDPE (e.g. for the intermediate fluid storage tank and/or the tubing for feed lines) or polyurethane (e.g. in foam sheet form for use as an insulating sheet in a panel arrangement in which the solar heat capture element may be formed) which are low cost and light weight may be used.

The fluid heating system of this aspect is characterized by the possibility of two or more fluid circulation arrangements and, in particular, the availability of circulation loops for management and transfer of heated fluid. The arrangement described above comprising the fluid circuit from an intermediate storage tank (or slave tank) via an inlet feed line to a solar energy capture element (or panel) and via an outlet feed line to the intermediate storage tank may be considered as a first fluid heat loop for capturing solar energy as heat in the fluid. The first fluid heat loop is particularly useful in capturing low grade solar energy, e.g. that available in the morning or evening or in winter.

In one aspect of the invention, the above solar water heating system (i.e. when the fluid is water above) forms a part of a solar water heating arrangement which further comprises a hot water storage vessel, such as a domestic hot water cylinder. The hot water storage vessel comprises a heat-insulated internal volume for storage of water to be heated and for storage of hot water to be drawn on demand by a user. For example, the hot water storage vessel in a household environment may be drawn from by a user for filling a bath, for a shower or for other household uses as and when required. Water drawn from the hot water storage vessel by a user according to this aspect is typically drawn from a demand outlet in the vessel. The demand outlet preferably draws water from an upper portion of the hot water storage vessel, which water will be the hottest water especially if heat stratification in the hot water storage vessel is allowed (as is preferred).

The hot water storage vessel according to this aspect is fed via a vessel inlet with solar heated water from the outlet draw line of the solar water heating system. Preferably, the vessel inlet is located at an upper portion of the hot water storage vessel so that solar heated water entering the hot water storage vessel from the outlet draw line may be added in an upper portion where the stored water is likely to be warmer (assuming some heat stratification) and more preferably the vessel inlet is configured to minimize disturbance to heat stratification (e.g. by slowly feeding heated water into the vessel inlet via a microbore pipe and/or by dribble feeding the water into the vessel). More preferably, the vessel inlet is located at the top of the hot water storage vessel and most preferably utilizes the same aperture as the demand outlet. Water fed from the outlet draw line of the solar water heating system to the vessel inlet is directly heated water directly from the solar heat capture element or panel and thus solar heated water is preferably delivered directly to the upper portion of the hot water storage vessel. If, for example, two litres of hot water at 60° C. is produced at solar heat capture element and delivered to the upper portion of the hot water storage vessel, that two litres of hot water is immediately available for use as hot water at around 60° C. This is particularly advantageous over the indirect heat-exchange solar systems wherein the fluid from the solar panel is circulated through a heat-exchange coil in the hot water storage vessel resulting in only a small rise in the overall temperature of the stored water when the solar energy available and thus requiring secondary heating of the stored water even for supply of a small demand.

Optionally, a microbore pipe is utilized for the outlet draw line, e.g. for a domestic hot water system from 5-15 mm, preferably about 10 mm bore.

The hot water storage vessel is typically provided with a vessel conduit, e.g. in a lower portion of the hot water storage vessel, for the transfer of cooler water from the hot water storage vessel to the solar water heating system.

This feature, the provision of water from the solar energy capture element (e.g. panel) or the outlet feed line to the hot water storage vessel via the outlet draw line and the return of fluid to the solar energy capture system (e.g. the intermediate storage tank or the inlet feed line) typically via the vessel conduit and then back to the solar heat capture element (or directly to the solar heat capture element) may be considered a second fluid heat loop. The second fluid heat loop involves circulation of fluid directly from the panel to a hot water (fluid) storage vessel or other hot water (fluid) utilizing device and return of water (fluid) to the solar fluid heating system and optionally directly back to the panel (or solar heat capture element). This second fluid heat loop is effective in directly using high grade heat and high grade solar energy captured by the fluid (e.g. water) when it has reached a desired or required temperature. This second heat loop comes into greatest use during hot sunny days, e.g. during summer months.

According to this aspect of the invention, in a preferred arrangement, it is configured such that when the temperature of water at the solar energy capture element or associated with the outlet draw line regulator is higher than or a predetermined increment higher than the temperature of water in the hot water storage vessel (and preferably the temperature of water in a lower portion of the hot water storage vessel), water from the outlet draw line is fed into the hot water storage vessel via the vessel inlet. Cooler water from the hot water storage vessel may then be fed the vessel conduit to the solar water heating system, preferably to the inlet feed line or also, or alternatively, to the intermediate storage tank.

Preferably, in order to achieve this, the hot water storage vessel is provided with a temperature sensor (a third temperature sensor) in its lower portion to measure the temperature of water in the lower portion thereof, whereby a relative temperature or temperature difference between the lower portion of the hot water storage vessel and the water heated by the solar heat capture element may be established and the first and third temperature sensors configured such that responsive to a difference or a predetermined incremental difference in temperatures, the aforementioned transfers of water may achieved. Preferably the water sensors in the arrangement are configured by connection to a controller for controlling pumps and/or regulators for control of fluid flow about the system responsive to temperatures and temperature increments relative to predetermined criteria.

The flow of water directly from the solar heat capture element to the hot water storage vessel is typically relatively slow and is determined by the solar energy available for capture and the relative temperatures (and predetermined criteria) of water associated with the solar heat capture element and in the hot water storage vessel. When a demand is made of the water volume in the hot water storage vessel (e.g. by a user drawing a bath, for example), the volume of water in the storage vessel may be replenished by drawing fluid directly from the solar heat capture element via the outlet draw line. However, such demand on water is preferably replenished via a vessel supply inlet fed by a vessel supply feed line from the intermediate storage tank of the solar water heating system. Preferably, a cold water feed (e.g. from a domestic mains supply or a domestic cold water tank) is provided to the intermediate tank as its fluid supply feed and more preferably the vessel supply feed line and vessel supply inlet replace any cold water feed that might be provided to a standard domestic hot water storage vessel. Preferably, there is no cold water mains supply to the hot water storage vessel other than via the intermediate storage tank.

This “demand circuit” is a third fluid circuit that may be utilized in a fluid heat management system of the present invention. The third circuit is not a circuit at all but comprises a supply inlet (typically a mains water supply) to the intermediate storage tank, a vessel supply feed line to transfer fluid from the intermediate storage tank to the hot fluid (water) storage vessel and a demand outlet from the hot fluid (water) vessel to the user.

Preferably, a vessel supply feed line from the intermediate storage tank of the solar water heating system draws water from an upper portion of the water in the intermediate storage tank, whereby if heat stratification is achieved the warmest water available is provided to the hot water storage vessel. This may be achieved by use of a buoyant draw means.

A buoyant draw means or variable level outlet is typically provided by means of a flexible pipe connected at one end to a relatively low-level outlet of the intermediate tank (e.g. at the lowest point of the tank) and at the other, open, end to a buoyant component (which may be integral or separate) for ensuring that the open end of the pipe is always positioned to receive fluid from the layer of fluid that is the warmest. As the water level reduces, so does the fluid receiving end of the draw pipe so that it is always available to draw on fluid in the upper layers within the tank. In an alternative form, although less useful in the present invention as the vessel feed line outlet from the intermediate storage tank, the variable level outlet hereinbefore described may be provided as a further and separate aspect of the invention, wherein the variable level outlet is provided with a further temperature-responsive flow regulator, preferably in the form of a valve in conjunction with a temperature sensor, such that fluid is only allowed to pass the variable level outlet if at a certain temperature. This may find utility in drawing fluid of a predetermined temperature from a heat stratified storage tank.

Optionally, the buoyant device and/or flexible pipe is also associated with an inlet supply such that when the overall fluid level in the tank falls below a certain level a fluid inlet is opened to allow fluid to enter at a low level in the tank, in the manner, for example, of a standard cistern, but arranged to minimize fluid disturbance. However, it is presently preferred to provide a separate fluid supply feed to the intermediate tank.

Optionally, the vessel supply inlet and the outlet conduit are the same feature, whereby water may be transferred out of the hot water storage vessel to the solar water heating system or transferred into the hot water storage vessel from the intermediate tank via the same aperture and optionally the vessel supply feed line is used for transferring cooler water from the hot water storage vessel to the intermediate tank. Preferably, however, a separate, typically smaller bore, e.g. a microbore, pipe is provided to transfer water from the hot water storage vessel to the solar water heating system (e.g. the inlet feed line or the intermediate tank).

In use, according to a preferred arrangement of the present aspect, a first temperature sensor is provided in association with the solar heat capture element (e.g. within or outwith the element and close to the element outlet or in the outlet feed line) or in association with the outlet regulator, a second temperature sensor is provided in association with the intermediate tank (e.g. in a lower portion of the intermediate tank or in the inlet feed line) and a third temperature sensor is provided in association with the hot water storage vessel (e.g. in the lower portion of the hot water storage vessel), each of the first, second and third temperature sensors being configured for connection with a controller which controls the flow of fluid about the arrangement using appropriate pumps and/or regulators according to a set of predetermined criteria. Typically, a pump will be provided at least to the inlet feed line and to the outlet feed line and/or outlet draw line in a balanced arrangement to allow circulation of fluid. The criteria may be set to whatever is appropriate for the system. For example, the flow of fluid from the solar energy capture element to the hot water storage vessel may be triggered to occur when the temperature at the first sensor is at least 50° C. and the temperature at the first sensor is greater than at the third sensor and the flow of fluid from the solar energy capture element to the intermediate storage tank may be triggered to occur when the temperature at the first sensor is at least 30° C., at least 5° C. higher than the second sensor and provided that the temperature of the first sensor is lower than the third sensor. Accordingly, when low grade heat is available, or there is no requirement for any further hot water in the hot water storage vessel, heat is captured in the intermediate storage tank. The intermediate tank acts as the source for water for the solar energy capture element and thus water of a higher temperature will be more readily generated and the intermediate tank also acts as source for volume replenishment in the hot water storage vessel and so partially heated water may be supplied in that situation rather than cold water.

In one embodiment a general control philosophy is established, which may optionally be adopted in the various aspects and embodiments described above and hereinafter. Accordingly, a pump is provided to pump fluid to the inlet of the solar energy capture element, which speed of the pump is determined by the temperature (or relative temperature) of fluid in the element, in association with the element fluid outlet or in association with a junction between the first and second fluid loops. The pump may be configured for pulsed operation whereby the pump alternates between on and off or high and low flow, the on/high flow pulse length optionally depending upon the relative temperature difference between the intermediate storage tank and the solar energy capture element (the greater the temperature differential, the longer the pulse) or solar water storage vessel. When the temperature at the panel element (or associated with the element fluid outlet or junction) reaches or exceeds a pre-determined desired temperature (e.g. 60 degrees Celcius), the pump is actuated to constant flow (for as long as that temperature is maintained), the flow of water being controlled to either the hot water storage vessel or the intermediate storage tank according to relative temperatures and established priorities (typically the hot water storage vessel is served first when water of sufficient heat is available). Thereby, low volumes of fluid may flow through the element when energy to be captured is low (e.g. at morning and evening) thereby capturing usable heat in low volumes of fluid rather than small heat increase in a large volume of fluid and when energy to be captured is abundant, the volume of fluid capaturing the heat is increased.

In one embodiment, a control philosophy may be established in a solar water heating arrangement (comprising a solar heat capture element, an intermediate tank and a hot water storage vessel) provided with a first temperature sensor, second temperature sensor and third temperature sensor as defined above and a first pump (associated with the solar water capture element inlet) and a second pump associated with the draw outlet to the hot water storage vessel, whereby if T¹ (temperature at first sensor) is greater than 10° C. and greater than T² (temperature at second sensor) plus 5° C., then the first pump is actuated on a pulsed flow to circulate water intermittently about the first fluid flow loop. If T¹ is also greater than 60° C., then the first pump may be actuated in full. If T¹ (or a fourth temperature sensor T⁴ associated with the junction between the first and second fluid flow loops) is greater than T³ (temperature of third sensor) plus 5° C., then the second pump is actuated to circulate fluid about the second fluid flow loop between the solar energy capture element and the heated fluid storage vessel. Further conditions on the control protocol can be applied according to desired management of fluid flow.

Optionally a system according to the present invention may be provided with a combination of two or more of the following temperature sensors which optionally may be utilized to manage respective fluid flows about the fluid flow loops:

T1—a temperature sensor associated with the outlet of the solar heat capture element;

T2—a temperature sensor associated with the lower portion of the intermediate tank;

T3—a temperature sensor associated with the lower portion of the heated water storage vessel;

T4—a temperature sensor associated with the junction of the first and second fluid flow loops (downstream of the solar heat capture element);

T5—a temperature sensor associated with a room to be heated by an optional central heating circuit;

T6—a temperature sensor associated with a fluid inlet to the solar heat capture element;

T7—a temperature sensor associated with fluid supply inlet to the intermediate storage tank (e.g. mains water supply);

T8—a temperature sensor associated with an upper portion of the intermediate storage tank;

T9—a temperature sensor associated with an upper portion of a heated fluid storage vessel;

T10—a temperature sensor associated with a mid-portion of a heated fluid storage vessel;

T11—a temperature sensor associated with the demand draw outlet;

T12—a temperature sensor associated with a space heating circuit outlet; and

T13—a temperature sensor associated with a space heating circuit inlet.

A further unique and beneficial feature of the arrangement according to this aspect of the invention is that as well as being useful for new-build systems, the arrangement can be produced by retrofitting to existing hot water storage vessels, both direct heat and indirect heat systems, without the need to drain the hot water storage vessel first. It is beneficial not to drain a domestic hot water storage cylinder since many such systems are aging and the nature of such systems is that there is a higher risk of failing, in particular the pumps and fittings. The arrangement is such that the feed lines can be connected to cause the arrangement to work without draining the cylinder. Other types of system such as solar heat exchange driven systems and even other direct heat capture systems but absent the intermediate storage tank generally need the system drained before they can be fitted.

In the above two aspects there are various arrangements of feed lines between the solar energy capture element, the intermediate storage tank and the hot water storage vessel. There are various embodiments in which these can be arranged but some preferred embodiments suit specific arrangements.

For example, in a domestic system according to one embodiment of the second aspect discussed above, an outlet feed line and inlet feed line may be configured to allow a circulation, a draw feed line may be provided with a smaller bore pipe (e.g. a microbore pipe), a vessel supply feed may be configured to allow large volume of water transfer (e.g. of larger bore and optionally provided with a pump). A return line may preferably be a small bore pipe since the volume of returned fluid should correspond with that provided by the draw feed line.

The fluid heating system and arrangement according to the invention is preferably a fully vented system. Accordingly, it is preferred that a vent is provided at the apex of the panel or adjacent thereto, in the outlet feed line, preferably in the inlet feed line (especially if there is a vessel return feed feeding into the inlet feed line) and adjacent the vessel inlet. The element outlet is preferably provided with an outlet feed line having a slight downward gradient away from the element outlet toward any pumps in that line or toward the intermediate storage tank. Further it is preferred that if a general downward conduit from the element outlet to the vessel inlet, that prior to reaching the vessel inlet, a trough in the pipeline is provided. This discourages feedback from the hot water tank back to the intermediate storage tank or solar energy capture element.

In one embodiment, the inlet feed line providing fluid from the intermediate storage tank to the solar heat capture element is provided with a vent associated with an elevated flow path; whereby a head of fluid is created downstream which is sufficient to drive the fluid through the solar heat capture element to the intermediate storage tank, a heated fluid storage tank or pump therefore. A pump should be provided upstream of the elevated flow path which should be of sufficient capacity to surmount the elevation. Accordingly, fluid may not siphon back into the intermediate storage tank. Preferably, as a further feature of this embodiment or as an independent feature in its own right, the system according to the present invention may be provided with a frost tank linked to the solar heat capture element. Optionally, the intermediate storage tank may act as a frost tank, but preferably a separate frost tank may be provided, which is fed by one or two conduits from the solar energy capture element or the inlet feed line thereto, which one or two conduits is fitted with one (reversible) or two pumps, which are preferably temperature-sensor actuated. Accordingly, when the temperature of the fluid in the solar heat capture element falls below a pre-determined temperature (e.g. 3° C. for water), a pump may be actuated to empty the fluid from the element into the frost storage tank, and when a temperature of air in the solar heat capture element exceeds a pre-determined temperature (e.g. 5° C.) a pump may be actuated to fill the solar energy capture element. Accordingly, frost damage to the solar heat capture element or panel may be avoided (e.g. if the element is glass).

In another aspect of the invention, a solar fluid heating arrangement is utilized for space heating and the arrangement comprises a solar energy capture element having an internal volume for containing a fluid to be heated, an element fluid inlet and an element fluid outlet, an intermediate fluid storage tank configured for fluid communication with the element fluid inlet and the element fluid outlet of the solar heat capture element, an inlet feed line for providing fluid to the element fluid inlet of the solar energy capture element from the intermediate fluid storage tank, an outlet feed line for feeding fluid from the element fluid outlet of the solar energy capture element to the intermediate fluid storage tank, and coupled with the intermediate fluid storage tank and/or coupled with the solar heat capture element a fluid-carrying space heating circuit, the arrangement configured such that when the temperature of the fluid in the intermediate fluid storage tank or the solar heat capture element is greater than or is greater than by a predetermined increment the temperature of the space in which the space heating circuit is configured to heat, fluid is caused to circulate through the space heating circuit thereby providing space heating.

In one embodiment, the circulation of fluid through the space heating circuit comprises circulation of fluid between the intermediate fluid storage tank or the solar heat capture element and the space heating circuit. In this embodiment, the fluid stored in the intermediate storage tank or heating in the solar heat capture element may circulate through the space heating circuit.

Alternatively, the fluid-carrying space heating circuit is coupled with the intermediate storage tank to utilize heat in the intermediate storage tank for space heating by way of a heat exchange coil located within the fluid contained in the intermediate fluid storage tank. In this embodiment, a separate fluid supplies the space heating circuit and the fluid in the intermediate storage tank is used only for capture of its heat in the separate fluid.

The space heating arrangement can be utilized as a sole purpose of the arrangement or may be integrated into a solar water heating arrangement such as that described above. Although the supply of solar hot water may be greatest in the summer, where the demand for space heating is the lowest, the pattern of use of hot water is very specific at any time of year and an integrated space heating arrangement may be an efficient utilization of excess low grade heat.

In a further aspect, the present invention relates to a continuous fluid pasteurization system comprising the solar fluid heating system described above wherein the outlet draw line is or is linked to a pasteurized fluid feed line and characterized by the outlet regulator being configured to allow passage of fluid to the outlet draw line or pasteurized fluid feed line only when the water has reached or exceeds a pre-determined pasteurization temperature.

Preferably, the system comprises at least one pasteurised fluid holding or storage vessel served by the outlet draw line or pasteurized fluid feed line.

In a further continuous fluid pasteurisation system aspect, the system comprises a solar energy capture element having an internal volume for containing a fluid to be heated, an element fluid inlet and an element fluid outlet, an outlet feed line for feeding fluid from the element fluid outlet of the solar energy capture element to an outlet draw line through which pasteurised fluid may be drawn, and an outlet regulator associated with the outlet draw line, said outlet regulator being responsive to temperature whereby fluid may pass the outlet regulator from the solar energy capture element through the outlet draw line only when a pre-determined temperature of fluid at the outlet draw line has been reached or exceeded.

In a preferred embodiment, the continuous pasteurization system comprises both an intermediate fluid storage tank and a pasteurized fluid holding or storage vessel (the latter which typically may be drawn from at any time). Preferably, the pasteurized fluid holding vessel is sized to allow 2 hours storage based on the demand for pasteurized fluid. This has a further advantage of allowing for the killing of persistent bacterial cysts which may not be instantly killed by the pasteurization process. In one embodiment, the system is provided with two pasteurized fluid holding tanks, either in series or in parallel, sized such as to allow two hours storage, and preferably of a heat-insulating material (e.g. HDPE). According to this embodiment, the pasteurized fluid feed line feeds to both holding tanks, filling one and then filling another and so on. Alternatively, the tanks are provided in series and the holding phase is timed for a pre-determined time (e.g. 2 hours) before pasteurized fluid is dispatched to the second holding tank where fluid can be drawn from as required.

Preferably, the system of these aspects of the invention comprises a vent which allows air or steam within the system and most particularly in the solar energy capture element to escape to atmosphere. The presence of the vent ensures that the system may operate without pressurization (which is preferred) and typically at about atmospheric pressure. Further, the operating temperature of the system may thereby be controlled to be up to about the liquid-vapour phase-transition temperature of the fluid, typically about 100° C. for water.

In a preferred embodiment, the pasteurized fluid feed line or a holding tank draw line (for drawing pasteurized fluid from the pasteurized fluid holding tank) [or where two holding tanks are provided in series, an inter-holding tank line] includes a heat exchange coil which is immersed in the intermediate fluid storage tank whereby heat from the pasteurized fluid may be transferred in part to the fluid in the intermediate storage tank and thus reduce the energy required to pasteurize such fluid and speed up the process. This is typically acceptable as it is typically preferred that pasteurized water, for example, is available for drinking and thus should be allowed to cool. Alternatively, an inlet feed line may pass through a heat exchange coil located in the pasteurized fluid storage tank (preferably the second in a series) to achieve a similar effect.

The systems of these aspects of the invention typically use a low cost apparatus and allow an improved, increased efficiency method for pasteurizing a fluid, especially a liquid such as water. By continuous pasteurization process, it is meant that a user may draw pasteurized fluid as and when required while the system continues to operate rather than a batch system.

Preferably, the fluid flow regulator is a temperature actuated valve. There may be more than one fluid flow regulator provided whereby the fluid allowed to pass to the pasteurized fluid feed line is controlled by a first regulator according to a temperature reading on a first sensor and where that condition is met but there is limited storage capacity in the pasteurized fluid storage vessel, the fluid is allowed to pass a second regulator in response to a second sensor to the intermediate tank (whereby heat may be recovered from pasteurized fluid that is not available for use). The first and second regulator and first and second sensor may be the same regulator (configured to manage flow through each conduit) and the same sensor.

Preferably, to ensure failsafe pasteurization arrangement, the passage of fluid to an outlet draw line or pasteurized fluid line requires two stages—a thermostatic valve which only allows throughflow when a predetermined pasteurization temperature is reached and a thermally responsive intercept pump which only allows a fluid to be pumped when it reaches a specified temperature.

In the selection of temperature by which a fluid flow regulator is operated, consideration must be given to how the fluid is handled after it is removed from the solar heat capture element. For example, if it is to be available for immediate use as drinking water, it will be necessary to select a suitable pasteurization temperature, such as 72° C. (e.g. at least 70° C.), while if it is to be stored in an insulated container for a period of time (e.g. a number of hours) before use, it may be possible to select a pasteurization temperature of say 60° C. Systems that allow the selection of temperature as appropriate will be described in more detail herein.

This invention has particular application in the pasteurization of water and especially to the pasteurization of water, e.g. from soiled or grey water, for drinking in areas and countries with inadequate municipal water supplies.

It is therefore a preferred embodiment of these aspects that the fluid is water.

The apparatus and method of the present invention will hereafter be described primarily with reference to water and pasteurization of water and especially to the production of potable water. However, it should be recognized that it is intended in the description hereafter that the embodiments may also apply, where the context allows, to the heating of water and space, to the pasteurization of water for other purposes and to the pasteurization of other fluids including foods such as milk.

By pasteurization temperature, it is meant a temperature at which, in the treatment being applied to a fluid such as water, a substantial proportion of harmful microorganisms may be eliminated. For example, a pasteurization temperature of 72° C. is capable of instant destruction of a number of harmful organisms such as protozoa, salmonella, hepatitis A and legionella, whilst a pasteurization temperature of 55° C. is capable of destroying harmful microorganisms in water if the water is held at that pasteurization temperature for a period of 4-5 h. Optionally the pasteurization temperature may be selected to be a sterilization temperature (e.g. 100° C.), but is preferably less than 100° C.

According to a preferred embodiment of the pasteurization system of the invention, the apparatus comprises a temperature actuated flow regulator as defined above wherein the pasteurization temperature is a value less than 100° C., more preferably less than 80° C. and still more preferably in the range from 50° C. or 55° C. to 75° C.

As mentioned above, a fluid pasteurization system or apparatus according to these aspects of the invention preferably comprises an outlet storage tank for receipt of fluid allowed to pass the outlet regulator. The outlet storage tank may be in the form of a single tank for containing pasteurized water to be used, e.g. for drinking water, by being drawn or dispensed from the outlet storage tank. Alternatively, the outlet storage tank may be in the form of a series (e.g. carousel) of containers that are filled directly from the fluid outlet of the solar energy capture element (or alternatively may be filled with water dispensed from a single, intermediate, outlet tank). Optionally, the filled containers may be capped automatically. The filled containers may be ready to use (e.g. if the pasteurization temperature is set to, for example, 70° C.) or alternatively, the carousel system may form a batch pasteurization system whereby water at a temperature of a lower pasteurization temperature, say 55° C., is dispensed into a container and that container (which is preferably formed of a heat-insulating material) held for a period of time appropriate to ensure effective pasteurization. This can be achieved by the use an indicator, examples of which are known in the art (e.g. a wax egg-timer style indicator), or a timer. Other batch ‘finishing’ systems can be conceived of from this continuous water heating system. That is, from a single outlet tank, water that has been heated to a pasteurization temperature of less than say 70° C. may be dispensed batch by batch into other holding units where the water is held at an appropriate temperature for an appropriate period of time. For example, the outlet tank may dispense water into one of two, preferably three, municipal supply tanks, in a continuous manner, one of which may be drawn from (after a certain storage period) while the other is being filled. Where three municipal supply tanks are being utilized, one may be filled, a second stored to complete pasteurization (if pasteurization temperature selected is less than 70° C. and a third available for use.

In one embodiment, especially in embodiments where the outlet regulator does not include a valve, the outlet storage tank is arranged relative to the solar energy capture element such that the water level in the outlet storage tank is higher than that of the solar energy capture element, or at least that the feed to the outlet storage tank is at a higher level than the water level in the solar energy capture element.

Optionally, fluid allowed to pass the fluid outlet of the solar heat capture element may be passed through a filter. The filter may be located between the outlet regulator and the outlet tank or downstream of the outlet tank if, for example, a single outlet tank is utilized. The filter typically comprises a biochar or activated carbon, but preferably utilizes a low-grade biochar (that can be produced locally for use of the system in developing countries) or activated carbon substitute and may be used to remove unwanted colouring or taste/odour from the pasteurized water.

A fluid inlet to the solar energy capture element according to the pasteurization aspects may be from any suitable source of fluid to be pasteurized. Typically, the fluid inlet may be supplied from an inlet storage tank. The intermediate storage tank of the invention may be utilized as the inlet storage tank or may be fed by a further inlet storage tank, which may optionally be a shallow unprotected well, for example.

Optionally, the inlet and outlet storage tanks are formed in a single tank in which the pasteurized and unpasteurised fluid is separated by a rigid or flexible division, whereby physical separation of the unpasteurized and pasteurized fluid is achieved in a single tank. Optionally, the pasteurized and unpasteurized fluid is separated in a single tank by a flexible division, such as a flexible membrane, whereby the total head of fluid may be maintained and the inlet storage portion only replenished when fluid is drawn from the outlet storage portion. In one embodiment, the means for drawing pasteurized fluid is via a flexible pipe located at the centre of the flexible membrane and fluid drawn from the upper (pasteurized fluid) portion through the lower (unpasteurised fluid portion) whereby the pasteurized fluid may transfer heat to the unpasteurised fluid. Optionally, the flexible pipe is configured as a heat exchange coil within the inlet storage portion to maximize heat exchange to the inlet fluid.

In an alternative embodiment of the above, the flexible membrane is heat conductive whereby heat from the heated pasteurized water may pass to the unpasteurized water. This is more effectively achieved if the pasteurized water is stored below the unpasteurized water (since heat rises), but this is a less preferred arrangement for the storage of pasteurized water.

In one embodiment, an internal division in the tank forms protrusions from one tank into another to ensure effective heat transfer.

Preferably, however, for most applications, separate inlet storage and outlet storage means are appropriate.

For uses of the above apparatus and systems and for processes which require pasteurization of fluid, e.g. for safe drinking water, but do not require that the fluid is heated, it is preferable to recover some of the heat of the pasteurized fluid in order to enhance the efficiency of the system. Accordingly, by way of a preferred embodiment, the invention in the various aspects described above preferably has a means for exchanging heat between pasteurized (outlet) fluid and unpasteurised (inlet) fluid without placing them in direct contact. The means for exchanging heat may take any suitable form, examples of which are described hereinafter.

In one embodiment, in which the apparatus comprises a separate outlet fluid storage tank (e.g. a pasteurized fluid storage vessel—in this context, pasteurized fluid storage vessel and outlet fluid storage tank may be used interchangeably) and inlet fluid storage tank (e.g. intermediate storage tank—in this context, intermediate storage tank and inlet fluid storage tank may be used interchangeably), the heat exchanging means comprises a separate heat exchange system comprising a coil or other conduit or pipe arrangement for heat transfer in each of the fluid storage tanks, said coils in fluid communication with each other and containing a heat exchange fluid (being a fluid that rapidly loses or gains heat, preferably in the range 0° C. to 80° C.). The heat exchange system may comprise heat exchange portion (which are portions of the piping immersed in fluid of the respective storage tanks) which portions of said pipe are efficient heat conductors (e.g. copper piping) and fluid transfer portions (for transferring fluid between the heat exchange portions) which fluid transfer portions are formed preferably of effective insulating material. The heat exchange fluid may be driven by an electrical motor or pump, which is optionally powered by a small photovoltaic device, or by thermodynamic means.

In an alternative embodiment, in which the system comprises an inlet fluid storage tank (containing relatively cool fluid to be pasteurized) and an outlet fluid storage tank (containing pasteurized fluid, which is typically relatively warm), the heat exchanging means may comprise a feed pipe of pasteurized fluid passing through the inlet storage tank or a feed pipe of unpasteurised fluid passing through the outlet storage tank, or both. For example, the fluid inlet to the solar energy capture element or assembly may typically be fed by an inlet feed pipe. The inlet feed pipe optionally is connected to an inlet fluid storage tank as the source of unpasteurised fluid for the system (but may be coming directly or ultimately from some other source). The inlet feed pipe may form the heat exchange means by arranging the inlet feed pipe through the outlet storage tank. The arrangement may be as low tech as coiling a flexible inlet feed pipe, the ends connected to the inlet storage tank and the fluid inlet of the solar heat capture element and dropping the excess piping into the outlet storage tank. Preferably, the arrangement is such that the inlet feed pipe is directed through an aperture, against which it is sealed, into the outlet storage tank (preferably toward the base thereof) to form therein a flexible or rigid coil or other such arrangement for heat exchange and directed out of the outlet storage tank (e.g. via an aperture formed near the top of the outlet storage tank) and then onward to the fluid inlet of the solar heat capture element. Similarly, and optionally in addition or alternative to the above, an outlet feed (connected at the fluid outlet of the solar energy capture element from the outlet regulator) which feeds pasteurized fluid to the outlet fluid storage tank may be redirected via the inlet fluid storage tank in a similar manner prior to delivering pasteurized fluid to the outlet storage tank (which will have then been substantially cooled). In each case, the fluid feed placed within the corresponding fluid storage tank may be termed the heat exchange feed portion (e.g. the heat exchange inlet feed portion or the heat exchange outlet feed portion). Optionally the heat exchange feed portion may be configured to occupy a volume of the corresponding fluid storage tank of from 10% to 70%, more preferably, 15% to 40% and most preferably 20% to 30%, thereby reducing the effective volume (for storage purposes) by a corresponding amount, which may be partially off-set by a corresponding heat exchange feed in the other fluid storage tank.

As discussed above, any suitable solar energy capture element or panel may be utilized with the systems and arrangements described herein. Preferably, the solar energy capture element may be of a particular form, examples of which are described hereinafter. A solar energy capture element forms a further aspect of the invention.

In a particular arrangement, there is a solar energy capture element for the capture of solar energy in a fluid to produce a fluid at a raised temperature, the element comprising a front solar radiation receiving surface, a back surface, an internal volume or fluid space between the front and back surfaces having a depth defined by the thickness of an edge, two side edges, an upper edge (upper being defined by its relative position in use), a lower edge, the direction from the lower edge to the upper edge defining a longitudinal direction, a plurality of longitudinal conduits arranged in a longitudinal direction, a first cross-conduit traversing the plurality of longitudinal conduits in an upper portion of the element, a second cross-conduit traversing the plurality of longitudinal conduits in a lower portion of the element, a fluid inlet for receiving fluid to be heated into the element, and a fluid outlet for dispensing heated fluid from the element, the fluid outlet being positioned in an upper portion of the element.

Optionally, a vapour vent (which may be the same or a separate aperture to that of the fluid outlet) may be provided to allow the release of air or fluid vapour, the vapour vent emanating from the element at a position in the upper edge or between the fluid outlet and the upper edge. In any case, the system for which the solar energy capture element is used should preferably be a vented, unpressurised system.

Preferably, the fluid outlet is located at an upper portion of the solar energy capture element (since heat stratification within the element will result in the warmest fluid being available in the upper portion) and optionally in the upper edge. The fluid inlet and fluid outlet may, but need not, be located at extreme opposing positions of the element, at least as far as the shortest path through a plurality of conduits is concerned. Preferably, the fluid inlet is also provided in the upper portion of the element, e.g. in the upper edge.

It is thus provided as a further aspect of the invention, a solar energy capture element having a front solar radiation receiving surface, a back surface, an internal volume or fluid space between the front and back surfaces having a depth defined by the thickness of an edge, two side edges, an upper edge (upper being defined by its relative position in use), a lower edge, a fluid inlet for receiving fluid to be heated into the element, and a fluid outlet for dispensing heated fluid from the element, the fluid inlet and fluid outlet being positioned in an upper portion of the element, preferably in the upper edge. Typically, the fluid inlet and fluid outlet are provided at opposing sides of the element or opposing ends of the upper edge. The front surface and preferably the front and back surfaces at least according to this embodiment are formed of the same material (e.g. polycarbonate sheet or glass). In one embodiment, the element is an adapted-sealed double glazing unit having a fluid inlet and fluid outlet formed in an upper edge thereof. Where there are no internal conduits or longitudinal conduits, the fluid inlet may enter the upper edge and feed to a lower portion to enhance heat stratification in the element.

Preferably, the front solar radiation receiving surface is formed by a first solar radiation receiving sheet which is translucent to at least a part of the solar spectrum, the back surface is formed by a second sheet and the plurality of longitudinal conduits are defined by a plurality of longitudinally arranged divider elements. The front and back surfaces and edges are preferably formed of polycarbonate.

According to one embodiment of the invention, the solar energy capture element is characterized by a plurality of conduits providing fluid communication between the fluid inlet and the fluid outlet, which volumes of said plurality of conduits make up the internal volume of the solar energy capture element. The plurality of conduits may be interconnected. Optionally, the solar heat capture element comprises a plurality of conduits providing fluid communication between the fluid inlet and the fluid outlet which provide a plurality of paths from the fluid inlet and the fluid outlet which paths are substantially equidistant. And optionally, according to this embodiment all fluid that enters the fluid inlet and exits the fluid outlet, has covered substantially the same distance irrespective of which of the plurality of conduits the fluid has passed through within the solar heat capture element. Thereby, the fluid that has been subjected to the greatest amount of sunlight at any one time is closest to the fluid outlet, ensuring efficiency of the system. Preferably the plurality of conduits are arranged in a manner that allows heat stratification to occur in each conduit such that fluid emanating from the top of each conduit is the hottest water in that conduit. The use of such stratification ensures that the heat is intensified at the upper portions of the solar energy capture element near the element outlet.

In one embodiment of this aspect of the invention, the solar energy capture element is in a panel, preferably planar, form of a material capable of conducting heat to the fluid contained therein or capable of allowing the passage of radiation in the spectrum of radiation absorption of the fluid contained therein. Optionally, the solar energy capture element is a container without internal divisions (and without a plurality of longitudinal conduits), but preferably it comprises a plurality of internal divisions which may be of varying size and position and preferably the internal divisions form a conduit and more preferably a plurality of interconnected conduits providing fluid communication between the fluid inlet and fluid outlet which inlet and outlets are still further preferably located at opposing portions of the solar heat capture element. The internal divisions and, in a preferred embodiment, the longitudinal conduits serve to prevent turbulence or internal eddies in the fluid within the solar energy capture element, which turbulence may affect the stratification of heat within the element.

Preferably the solar heat capture element is a panel element comprising internal divisions defining a plurality of conduits providing a plurality of routes for water to move from the inlet to the outlet. Optionally, for example, the panel element may comprise a plurality of parallel internal divisions each fed from or traversing a single common first cross-conduit or perpendicular conduit (i.e. substantially perpendicular to the direction of the parallel conduits) or manifold which itself is fed from the inlet or which is formed in a lower portion of the element, and each feeding into a second single common cross-conduit or perpendicular conduit (i.e. substantially perpendicular to the direction of the parallel conduits and substantially parallel to the direction of the first perpendicular conduit) or manifold, which itself feeds to the outlet or is located in the upper portion of the panel (but is preferably associated with or feeds to the fluid outlet). According to this (and similar) arrangements, dead space within the panel is reduced (i.e. the heating capacity of solar energy hitting the panel is utilized most efficiently), a blockage occurring in a conduit is unlikely to prevent operation of the system and the head required to drive fluid from the inlet to the outlet in operation is minimized.

Preferably, the panel comprises a third cross-conduit or perpendicular conduit which is positioned at the upmost portion of the solar energy capture element for the collection of air or steam from the fluid in the element. The air or steam may then be vented off through a vent located at the apex of the system and optionally at the upmost position in the panel element. Optionally the third cross-conduit and the second cross-conduit are the same conduit, which may be longitudinally extended (i.e. extended in an upward direction) to form a broader or wider cross-conduit serving the fluid outlet (and optional vent).

In another particular arrangement, there is a solar energy capture element for the capture of solar energy in a fluid to produce a fluid at a raised temperature, the element comprising a front solar radiation receiving surface, a back surface, an internal volume or fluid space between the front and back surfaces having a depth defined by the thickness of an edge, two side edges, an upper edge (upper being defined by its relative position in use), a lower edge, the direction from the lower edge to the upper edge defining a longitudinal direction, a fluid inlet for receiving fluid to be heated into the element, a fluid outlet for dispensing heated fluid from the element, the fluid outlet being positioned in an upper portion of the element (and preferably the fluid inlet is positioned in an upper portion of the element). The element according to this arrangement preferably resembles (or is) an adapted double glazing unit adapted to receive a fluid outlet conduit in one (the upper) edge and a fluid inlet conduit preferably in the same (upper) edge and configured to deliver inlet fluid to the lower portion of the element to retain stratification of heat. Preferably, one sheet of the double glazed unit is pigmented preferably black or is coated internally or externally with a black coating. In this arrangement the front and back surfaces are preferably formed of glass (e.g. strengthened glass) and preferably define a space of 10 to 20 mm therebetween.

In use, the element according to a preferred embodiment operates without pressurization, by which it is meant that the system is open to atmosphere. Accordingly, fluid typically does not leave the element unless a pump is applied or pressure otherwise applied to the fluid at the fluid inlet. In one embodiment, the fluid outlet is located in an upper portion of the element but not at the upmost extreme whereby a air/steam vent may be located at the upmost extreme or apex of the element and the fluid outlet may be located a short distance (e.g. in the range of 2 to 5 cm) below.

According to one preferred embodiment, the solar energy capture element having an inlet and an outlet and an optional air/steam vent, in the manner described above, and operable as an unpressurised system, allows in operation fluid to pass the fluid outlet openly or on reaching or exceeding a pre-determined temperature. Accordingly, for example, when the temperature of the fluid is below the pre-determined temperature, the fluid remains within the element and forms a fluid level at or below the optional air/steam outlet and typically at or immediately below (depending on whether the fluid outlet is open and/or whether any inlet and outlet pumps are in balance) the fluid outlet. When, a pre-determined temperature is reached or exceeded, the fluid outlet if fitted with a regulator or valve allows the passage of fluid and the fluid is caused to pass the fluid outlet by feeding fluid into the fluid inlet, driven typically by an inlet pump. A hydraulic gradient will typically form in the solar energy capture element when fluid is being pumped into the element.

The solar energy capture element may be of any suitable size according to requirements. In the form of a panel assembly, it is preferable that the panel has a depth of up to 20 cm (e.g. 5-20 cm), preferably up to 10 cm. The heat energy capture element is preferably a planar sheet element having a depth of up to 5 cm, still more preferably up to 2.5 cm and optionally in the range 0.5 cm to 1.5 cm. The depth of the element may be selected according to the overall volume required of a panel (along with the height and width dimensions) having regard for the amount of space available and the strength of the sun in the locality. Typical dimensions include 6′×6′ or 8′×4′. Since the element is preferably for use in a continuous solar pasteurization process of the invention, the depth should preferably be selected such that solar energy may be efficiently captured over the area of the panel. Preferably, the depth is chosen to be in the range from 0.5 cm to 2.5 cm, more preferably 0.5 cm to 1.5 cm. Any suitable width and height may be selected according to the space available for the panel element. For example, the panel element may be from 30 cm to 5 m in width, more typically from 50 cm to 2 m in width. The panel element may be any suitable height, such as from 20 cm to 3 m in height, more preferably from 50 cm to 1.5 m. Preferably the ratio of height to width of the panel is in the range from 5:1 to 1:5 preferably 4:1 to 1:4, more preferably in the range from 1:3 to 1:1 and most preferably 1:2 to 1:1.

The solar energy capture elements, especially as panel elements, may interconnect in modular form. Accordingly, in one embodiment, a solar energy capture system or assembly may comprise a plurality of elements described above arranged in parallel or in series. Where a plurality of modular elements are connected in series, the outlet of a first modular element (being the first in the water inlet flow direction in normal operation) may be connected to the inlet of a second modular element via a first interconnecter and the second modular element may be connected at its outlet to an inlet of a third modular element (if present) via a second interconnector. The last in the series (the ultimate modular element) may, if desired, have at its outlet or in the outlet feed line a temperature sensor associated with flow regulation means (e.g. an inlet pump) which is responsive to temperature whereby it causes the passage of fluid from the solar heat capture assembly when the fluid reaches a pre-determined temperature (e.g. a pasteurization temperature).

The first, second and subsequent interconnectors may be in the form of short conduits (e.g. flexible tubing), preferably having a diameter of no less than the diameter of the outlet or the inlet to which each is connected. Thereby, the series of panel elements may be considered to form, in effect, a single larger volume heat capture panel element in which the first panel element in the series provides initial heating and subsequent panel elements provide additional heating until the temperature at the ultimate outlet reaches a temperature sufficient to cause the outlet regulator to allow the passage of fluid or to cause an inlet pump to actuate. Optionally, one or more interconnector may comprise a corresponding side outlet, itself having a manual valve or preferably a temperature-responsive regulator which will typically be set to the same or a higher temperature to that of the ultimate outlet fluid regulation means of the solar heat capture assembly whereby fluid at a pasteurization temperature may be drawn from the solar heat capture assembly at one or more additional points between the inlet and the ultimate outlet. According to this embodiment, the throughput of the system may be increased in an environment in which the solar heat captured is greater than the capacity of the system to drive fluid through the full series of panels.

The interconnectors may further be fitted with a through-flow regulation means, which is optionally an on/off valve or a temperature responsive regulator. The provision of an on/off through-flow regulator and a side-outlet with side-outlet regulator as a feature of one or more interconnector allows for the effective size of the panel to be reduced depending upon requirements (e.g. if one of the higher positioned panels is damaged). Optionally, the through-flow regulator may also be temperature responsive, whereby each module element of the solar heat capture assembly will heat the fluid to a pre-determined temperature before it will be allowed passage to the next panel. The temperature responsiveness of each through-flow regulator may be arranged automatically according to the volume of each module element and the ultimate target temperature.

Alternatively, and preferably, a moldular panel assembly may be formed of multiple elements connected in parallel. There are three configurations. In a first, the modular assemble comprises elements working as a single large element having a single fluid inlet. The elements are connected to one another at least at the bottom (in association with the lower cross-conduit) whereby cool inlet fluid can flow along an extended lower cross-conduit formed along the multiple elements, and optionally at the top (in association with the upper cross conduit). Whilst the elements may be connected in series, they are not in true series since they will be connected bottom-to-bottom and operate in parallel. The outlet may be a single interconnected outlet port or may comprise multiple outlets (one from each element) feeding into a manifold pipe. Optionally, as single sensor may be provided to determine the fate of the combined output from the multiple elements. This is a preferred modular configuration. In a second configuration, the modular assembly comprises elements working as a single, large, multi-port element. According to this configuration, a single inlet feed line driven by a single pump feeds into an element fluid inlet of each element and once a pre-determined temperature (or pre-determined average temperature) is reached according to one or more temperature sensors, the inlet pump is actuated and the fluid from each element collected in a single fluid outlet conduit. In the second configuration, which comprises a plurality of independent panels working in parallel, multiple inlet feed lines are provided from the intermediate storage tank, one to each element, and each provided with its respective inlet pump controlled by the temperature sensor in its element. Alternatively, each fluid inlet may be controlled by a valve and the assembly served by a single pump. The fluid outlets may feed multiple outlet conduits or may each feed into a single fluid outlet feed.

The solar energy capture element or assembly, or panel element(s) may be formed of any suitable material (capable of allowing solar energy to be transferred to the fluid contained within the element). Optionally, the solar heat capture element(s) are formed of a material that absorbs sunlight and transfers heat energy to the fluid. However, preferably, it comprises a heat-insulating material that is allows solar radiation to pass through the radiation-receiving surface of the element into the fluid contained therein, which fluid may absorb said solar radiation as heat. Optionally, a panel may comprise of a first, radiation receiving surface of a material substantially translucent to solar radiation (or at least translucent to wavelengths of radiation that may be absorbed by the fluid, e.g. water) and a second, underside, surface that is absorbent to broad spectrum solar radiation to absorb radiation not absorbed by the contained fluid and convert such non-absorbed radiation to heat for transfer to the contained fluid. Preferably the first and second surfaces should be heat-insulating materials for the purpose of reducing heat loss from the fluid back through the surfaces of the element. Still more preferably, the material for use in the solar heat capture element may be low cost and lightweight.

Materials for use in the solar heat capture element(s) include any suitable materials and preferred materials may be transparent rigid plastic or composite heat insulating material having thermal stability of greater than 120° C., preferably greater than 150° C. Preferred materials include polypropylene-containing materials, polycarbonate-containing materials and composite materials (such as glass fibre composites). Preferably, the solar heat capture element is formed of polycarbonate, optionally comprising a first surface of polycarbonate substantially translucent to solar radiation and a second surface substantially absorbent of solar radiation (e.g. by coating onto or incorporating into the polycarbonate a pigment or dye having broad spectrum absorption properties). Preferably carbon is incorporated into the second sheet of polycarbonate, which forms the back of the solar energy capture element. A solar energy capture element comprising polycarbonate (preferably recycled polycarbonate) is a further aspect of the invention, wherein the element comprises a first polycarbonate sheet and a second polycarbonate defining therebetween an internal volume for containing a fluid to be heated, the internal volume having a fluid inlet, a fluid outlet and a plurality of longitudinal channels within the internal volume defined by plurality of divider elements, wherein the first polycarbonate sheet is translucent to solar radiation and the second polycarbonate sheet is coated or impregnated with a broad spectrum dye or pigment, such as carbon black, for absorbing solar energy. Preferably the divider elements also are impregnated with a broad spectrum dye or pigment, such as carbon, for absorbing light. Such an element is capable of allowing the passage of light for absorption by the fluid to be heated and absorbing further solar radiation and converting it to heat and infra-red radiation allowing more efficient capture of solar energy.

Materials may be used in the panel which have reduced robustness at high temperatures than required in conventional solar heating panels (which use, for example, materials such as glass and stainless steel) since the system of the invention is not designed to reach temperatures of greater than 100° C. Pasteurisation temperatures or other pre-determined temperature for a solar heating arrangement (at which the outlet fluid flow regulator will be set to open) may typically be in the range 50° C. to 75° C. or may be set to, e.g. 90° C. or 100° C. if desired. This is typically close to the maximum temperature that the panel will be exposed to reach. In the event that the temperature exceeds that, the solar heat capture assembly, according to a preferred embodiment, will be fitted with a steam bypass to allow release of steam to the atmosphere thereby limiting the temperature of the panels to about 100° C.

In one preferred embodiment, the panel element or modular panel elements are formed by modification of a multi-wall polycarbonate sheet, preferably twin wall, defining a plurality of parallel conduits modified to interconnect the parallel conduits with two perpendicular conduits as described above. One example of a suitable polycarbonate sheet is the twin-walled polycarbonate sheet marketed under the trade name SUNLITE™ by PALRAM Industries. Another example of a suitable polycarbonate sheet is the twin-walled polycarbonate sheet marketed under the trade name Marlon ST Longlife™ by Brett Martin.

The use of relatively low temperatures in a system according to the present invention allows the use of low-cost lightweight materials in the solar heat capture elements and panel elements. This is a unique feature of the present invention as compared with conventional systems. Accordingly, in a further aspect of the invention, there is provided a solar energy capture element in panel form having an internal volume for containing the fluid to be pasteurized, the element having a fluid inlet for introduction of fluid to be pasteurized, a fluid outlet for passage of fluid at a pasteurization temperature and, optionally, an outlet regulator associated with the fluid outlet, which outlet regulator is responsive to temperature whereby fluid may pass the outlet when a pre-set pasteurization temperature is reached, said element further characterized in that the internal volume is defined by a first, radiation-incident, sheet, a second sheet and edge portions, wherein at least one of said first and second sheets comprise a polypropylene or polycarbonate material.

In use, when the temperature of the fluid in the solar heat capture assembly reaches the selected pre-determined temperature and the optional regulator allows passage of fluid at the pasteurization temperature through the fluid outlet, the fluid is driven through the outlet from one or more of the head of water in an inlet storage tank (which is preferably at least 0.5 m of head, more preferably at least 1 m of head and preferably in the range 0.5 m to 3 m, e.g. 0.5 m to 2 m), gas (typically air) pressure within the system derived from heating water, causing dissolution of dissolved gas, and a pressurized inlet supply by way of an inlet pump (which may optionally be connected to the outlet regulator so as to be actuated when the outlet regulator allows passage of fluid). Preferably, the apparatus is operable under pressure of 1.5 m head or less.

In an alternative embodiment, a solar energy capture element may comprise of an arrangement of a plurality of pipes having a fluid inlet and a fluid outlet, the plurality of pipes defining a plurality of conduits leading from the fluid inlet to the fluid outlet, each route being substantially similar in length. The plurality of pipes are typically arranged in two cross pipes (e.g. as perpendicular conduits forming a manifold), e.g. being an inlet cross pipe and an outlet cross pipe, and a plurality of longitudinal pipes connecting the two cross pipes, which longitudinal pipes are typically substantially parallel. The pipes may be made of any suitable material, e.g. copper or iron, but more preferably a translucent plastic material such as polyethylene or polycarbonate. A more robust and simple solar panel may be utilized with the pasteurization and solar heating systems of the invention for use, for example, in developing countries, in which a translucent or heat conductive element such as that described above may be blackened for heat absorption and placed on a blackened galvanized iron roof, with an translucent insulated cover and simple insulative material at the edges and optionally the underside of the roof.

A steam/vapour bypass is preferably provided in the pasteurization system of the invention to allow steam/vapour to vent to atmosphere and prevent temperature and pressure build up within the system. The steam bypass should preferably be incorporated at a position to be above the height of the solar heat capture element when in use and is preferably associated with the fluid outlet. For example, the steam bypass may be positioned between the fluid outlet and an outlet tank and more preferably between the outlet regulator and an outlet tank. Preferably, the steam/vapour bypass is located at a point higher than an outlet tank and preferably at the highest point of the system.

The solar energy capture element and continuous pasteurization system of the present invention is capable of highly efficient utilisation. For example, it is believed that a 12 m² panel in Kenya (assuming daytime temperature of 35° C., temperature of source water of 25° C.) can produce a peak volume of pasteurized water of up to 460 litres/h.

A solar panel according to a further aspect comprises a planar solar energy capture element for capture of solar energy in a fluid in its internal volume, the planar solar energy capture element comprising a front solar radiation receiving surface; a first layer of sheet insulation located in front of the front solar radiation receiving surface of the solar energy capture element, the first layer of sheet insulation being translucent to at least a portion of the solar radiation spectrum; a second layer of sheet insulation located behind the solar energy capture element; and a panel frame for holding the assembly of solar heat capture element and the first and second layers of insulation together, the panel element comprising a front gripping element and a rear gripping element configured to abut the front and rear of the assembly and to have applied between the front and rear gripping elements sufficient tension to hold the assembly in place, whereby it allows relative movement and thermal expansion of the solar heat capture element and the first and second layers of sheet insulation.

Preferably, the solar energy capture element is as described in detail above according to various embodiments.

Preferably, the first layer of sheet insulation is a double-wall polycarbonate sheet. The second layer of sheet insulation is preferably a polyurethane foam sheet.

Since in preferred embodiments of the above aspects, the operating temperature for a system or arrangement heating water (for pasteurization, space heating or hot water provision) is no more than the boiling point of water at atmospheric pressure (i.e. 100° C.), it is recognized by the inventor that the intermediate fluid storage tank, which may contain volumes of warm or hot water, may be made of a material with relatively low specification in terms of heat performance. For example, the intermediate fluid storage tank may preferably be made of high-density polyethylene (HDPE) or similar material, and as such new or redundant cold-Water tanks may be utilized (as the standard domestic cold water tank in the UK is a HDPE tank). According to a further aspect of the invention, there is provided a solar water heating system comprising a solar energy capture element having an internal volume for containing a fluid to be heated, an element fluid inlet and an element fluid outlet; and a water storage tank configured for fluid communication with at least the element fluid outlet of the solar heat capture element, an inlet feed line for providing fluid to the element fluid inlet of the solar energy capture element (optionally from the water storage tank), an outlet feed line for feeding fluid from the element fluid outlet of the solar energy capture element to at least the water storage tank; an air or steam vent located at an upper portion of the solar energy capture element or of the element fluid outlet, the system characterized in that the water storage tank is an HDPE tank. In a still further aspect, there is provided and HDPE tank having a first aperture in a lower portion of the tank for receiving a fluid supply line, a second aperture in a lower portion of the tank for receiving a solar panel inlet feed line and a third aperture in a lower portion of the tank for receiving a vessel supply feed line. Preferably, the tank is provided with a lid and the lid and/or upper portion of the tank is configured to receive a solar panel outlet feed. Also preferably, the tank comprises configured for connection with a vessel supply feed line at the third aperture a variable level outlet device.

The outlet regulator according to the present invention regulates the temperature at which fluid is passed from the solar heat capture element through the fluid outlet to, for example, an outlet storage tank. In one embodiment, the outlet regulator comprises a temperature responsive valve, which opens when the temperature of the fluid reaches a pre-defined value (e.g. 70° C.). In this embodiment, the fluid may be driven through the system by any suitable means such as described above (e.g. by exposing the fluid inlet to positive pressure of fluid, e.g. by having a sufficient head of fluid and a restriction valve in communication with the outlet valve and temperature sensor), but preferably by an inlet pump which is in signal communication with the temperature actuated valve, the inlet pump being located in association with the fluid inlet (e.g. between an inlet storage tank and the fluid inlet), whereby the inlet pump is actuated to pump fluid into the solar heat capture element when the valve is open.

Alternatively, the outlet regulator may comprise of a temperature sensor at the fluid outlet, which may be in signal communication with an inlet pump being located in association with the fluid inlet, whereby the inlet pump is configured to actuate when the temperature sensor indicates fluid at a certain minimum temperature (e.g. 70° C. and above). In this embodiment there is no valve on the fluid outlet and passage of fluid is regulated only by positive pressure from the system (i.e. from the inlet pump). Alternatively, instead of providing a positive driving pressure to the fluid inlet by way of a pump, the positive pressure can be achieved by ensuring sufficient head of fluid from the inlet storage tank (e.g. locating it two or three meters above the inlet) in association with a flow restrictor valve which may be in signal communication with the temperature sensor such that as the temperature reaches a pasteurization temperature, the restrictor is signaled to open allowing the head of fluid in the inlet storage tank to drive fluid through the system.

Preferably, the fluid inlet is provided with a one-way valve (e.g. associated with an inlet pump) to ensure that fluid passes into the solar heat capture element and not back into the inlet storage tank. Alternatively, this may be achieved by ensuring that the head of water in the inlet storage tank is sufficient (e.g. the level of fluid in the inlet storage tank is at least that of the solar heat capture element).

In a further aspect of the invention or as an embodiment of solar fluid heating system and/or solar fluid heating arrangement aspects of the present invention, there is provided a variable speed inlet pump for pumping fluid into a solar heat capture element according to pre-determined criteria, wherein the actuation and speed of the pump is controlled by a controller in signal communication with the pump, a first temperature sensor associated with a fluid outlet of the element and a solar intensity sensor (e.g. comprising a photovoltaic cell), the actuation and speed of the pump being according to the relative value of the feedback signal from the first temperature sensor to the pre-determined criteria and the solar intensity signal and optionally a moderating signal from a second temperature sensor in signal communication with the controller and indicative of the fluid inlet temperature. A feedback signal from the first temperature sensor may be considered a lag indicator (as it is determined by the previous speed of the pump and the previous intensity of sunlight and the initial temperature of the water) and the solar intensity signal may be considered a lead indicator as would the fluid inlet temperature.

A fluid pasteurization system as described above may be used, in accordance with a further aspect of the invention, for solar heated shower applications, wherein the water is pasteurized to remove the risk of legionella and other virus and bacterial risks (which are particularly problematic in shower systems, e.g. in shower heads). The elements of the various aspects of the invention described above (except the heat-exchange features, since this application requires pasteurization and heat) may find application in a solar heated shower and deployable solar shower system. A particularly advantage of the solar heated shower system according to this aspect of the invention is that grey water can be safely used in a solar heated shower, for example in a rapidly deployable system with no reliable clean water available.

According to a preferred embodiment of the invention, the solar shower system may comprise a solar heat capture element (which may be an assembly of panel elements as described above) having a fluid inlet fed from a source of water to be pasteurized (e.g. an inlet fluid storage tank) which may be pumped into the solar heat capture element (or fed in under pressure of sufficient head of water) a fluid outlet and associated outlet regulator (as described above) and optionally an insulated outlet storage tank. Alternatively the outlet may lead directly to a shower head fitted with a valve. Preferably, however, a shower head fitted with a valve is fed from an outlet storage tank.

According to preferred embodiments of aspects of the invention set out above, there may be provided rapidly deployable solar water pasteurization systems and rapidly deployable solar shower system. Such system comprise the essential elements and optionally preferred elements respectively described above, which may be in a particular rapidly deployable form. For example, the solar heat capture element may be provided in a collapsable and rapidly deployable form, for example, comprising a first flexible sheet (optionally radiation receiving sheet which is preferably translucent to solar radiation) and a second flexible sheet (optionally backing sheet which may be a pigmented for absorbing radiation), which first and second flexible sheets may optionally be polyethylene sheets of sufficient thickness (e.g. 0.1 to 0.5 cm) to render them sufficiently rugged, which first and second sheets are bound (or configured to be joined by) a plurality of substantially parallel rigid dividing elements. In use, the dividing elements serve to define a substantially parallel series of conduits. In the absence of stiffening members, or stanchions, the element is collapsible such that it comprises a stack of rigid dividine elements (preferably of polycarbonate) and a concertina of flexible first and second sheets. To form the panel for use, a cross-member acting as a stiffening member or stanchion may be clipped onto the dividing elements perpendicular to the direction of the substantially parallel conduits, which cross-member comprises a conduit when in position is substantially perpendicular the parallel conduits to form a manifold. A cross-member on each end of the parallel dividing elements provides respectively an inlet manifold and an outlet manifold. Each of the inlet manifold and outlet manifold is provided respectively with a fluid inlet and a fluid outlet.

A deployable tank may be used as the inlet storage tank and the outlet storage tank. For example, a tank may comprise a rigid circular base, a rigid rim and therebetween a flexible material such as plastic optionally fitted with a plurality of concentric ribs to assist in concertina formation. In use, three, four or more stanchions may be inserted to render the tank rigid. An aperture is provided for the inlet and outlet feeds. Other arrangements for rapidly deployable tanks can be conceived of.

Flexible hoses are preferably provided as the pipe work.

The preferred embodiments of the aspects of the invention described herein typically operate an unpressurised system, preferably by providing a steam vent or outlet at the upper portion of the solar energy capture element or associated with the element outlet. Accordingly, when overheating occurs, steam is generated and removed from the system via the air or steam vent, which allows the system to operate at atmospheric pressure and temperature up to about 100° C. This generated steam could be condensed to provide distilled water and/or the heat captured utilized. Alternatively, the generated steam could be fed to provide industrial or commercial steam requirement or fed to a steam turbine for use in generating electricity, although this will likely require pressurization of steam which is not in line with the fully vented aspects of this invention. There are various manners of utilising steam in electricity generation. One example requires a pressurized tank (which would be pressurised, for example, using a pump on the turbine inlet line), a generator, a means of cooling waste water for the process. Accordingly, electricity may be generated at a time when the supply of energy outstrips demand or in low-demand daytime periods or the panel utilized purely as a steam generation element for electricity generation.

According to a further aspect of the invention, there is provided a method for the capture, control, management and/or storage of heat in a fluid (e.g. water) from a heat source (e.g. a solar panel, such as a solar water heating panel) by providing for multiple fluid circulation loops (also referred to herein as heat loops) between multiple storage vessels for optimum efficiency. Preferably, the method is as defined above as the fifth aspect of the invention. According to this method, a heat loop may be considered to be a circulation of fluid about a circuit or transport of fluid from one location to another within a system. A first heat loop may be provided to capture low grade heat, that would otherwise be lost, by capturing the heat from the heat source in a fluid and transferring the fluid to an intermediate storage tank or slave tank. For example, such low-grade heat may be that heat transferred to water (or other fluid) in a solar water heating element or panel in periods of partial sunlight or in winter months. Such conditions may not be capable of efficiently heating the water (or fluid) to a level sufficient to displace from existing water from a hot water storage vessel or it may be calculated for such conditions to capture and store energy required to heat a large volume of water by 10° C. than a small volume of water by 30 or 40° C. The provision of a first heat loop capturing heat in water when the temperature reaches a first, low threshold, level and circulating it to an intermediate storage tank (preferably the upper levels of an intermediate storage tank which is heat stratified) allows such low grade heat to be captured and stored. A second heat loop may be provided to capture high grade heat by capturing the heat from the heat source in a fluid and transferring the fluid to a heated fluid (or hot water) storage vessel configured to store said heated fluid and insulated to retain the heat until required, e.g. on demand by a user. Such high-grade heat may be that heat transferred to water (or other fluid) in a solar water heating element or panel in periods of full sunlight or in the middle of the day in summer months. Such conditions may be capable of efficiently capturing the heat in the water (or other fluid) in an efficient manner whereby it can displace cooler water in a hot water storage vessel (available for drawing upon demand). Preferably, the first and second heat loops are configured to be selected automatically according to the relative temperature of heated fluid being produced by the heat source, the heat of the coolest fluid in the heated fluid storage vessel and the heat of coolest fluid in the intermediate storage tank, which configuration is typically provided by an arrangement of sensors, pumps and/or valves and a cpu or controller. The first heat loop may be utilized even when high grade heat is available if the heated fluid storage vessel is sufficiently heated, thus the high grade heat may be stored in fluid in the intermediate (or further, subsidiary, intermediate) storage vessel. A third ‘heat loop’ or fluid transfer may be provided when a user or other purpose demands heated fluid from the heated fluid storage vessel. The heated fluid removed should be replenished. The method of the present aspect preferably achieves this by providing partially heated fluid from one or more intermediate and optional subsidiary intermediate fluid storage tanks. In existing systems, such replenishment fluid is provided by unheated fluid which then has to undergo further heating (e.g. by the heat source, such as a solar panel or an internal heat source such as a electric or other heat coil in the heated fluid vessel). The preferred embodiment of the present aspect of the invention provides improvements in efficiency by replenishing the fluid removed upon demand from the heated fluid storage vessel, with partially heated fluid (from low grade heat) in the intermediate vessel. Such replenished fluid is typically provided to the lower portion of the heated fluid storage vessel, which is preferably heat stratified. Accordingly, any further heating of fluid in the heated fluid storage vessel (whether from high-grade heat from the heat source, such as a solar panel, or by a further heat source such as a internal heater coil in the heated fluid storage vessel) is a lesser requirement than otherwise in order to reach the desired temperature. Preferably, the intermediate tank fluid is replenished from a source; in the case of water as the fluid, from a cold water storage tank or a mains supply.

Preferably, according to this aspect, the method comprises providing the flow of fluid about respective fluid circulation loops according to a set of pre-determined and optionally variable criteria, in particular actual temperatures and temperature differentials between one or more temperature sensors at various locations in the system, which may optionally be selected from one or more of those described above. Thus the method may further comprise prioritizing the flow of fluid about one or more fluid circulation loops over one or more other fluid circulation loops. In a preferred embodiment, a second fluid circulation loop is prioritized when a temperature in a heated fluid storage vessel is hotter than or a pre-determined amount hotter than the fluid associated with the solar energy capture element or element outlet.

The above method may be further adapted by providing one or more further method steps as hereinbefore described as appropriate or by the provision of system or apparatus features described herein (especially in relation to respective first, second and third heat loops). A controller preferably is capable of being programmed to manage the heat in most efficient manner according to the themes hereinbefore described, typically by use of sensors in the upper and lower portions of each storage vessel and in the heat source (or solar panel).

The invention will now be described in more detail, without limitation, with reference to the accompanying Figures.

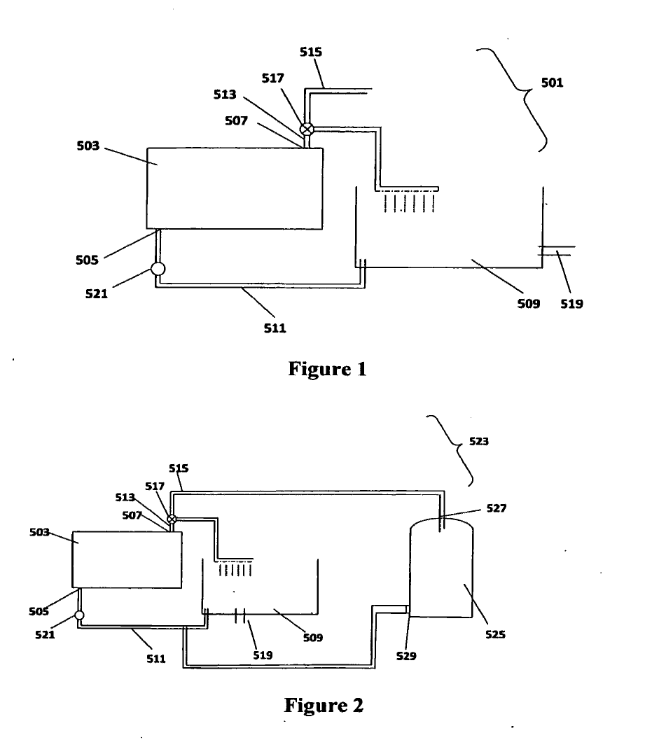

In FIG. 1, a solar fluid heating system 501 having general application comprises a solar energy capture element or solar panel 503 forming a fluid circuit with an intermediate fluid storage tank 509. The solar energy capture element 503 (a solar panel) has an element fluid inlet 505 fed by an inlet feed line 511 from the intermediate fluid storage tank and an element fluid outlet 507 which feeds fluid to the intermediate storage tank via an outlet feed line 513. This forms a first loop or circuit which can be used to efficiently capture low grade heat from the solar energy capture element or panel 503, especially in low intensity light situations where the solar energy being captured by fluid in the panel is not required (timeliness) or of sufficient heat for the demand requirement. The element fluid outlet 507 or outlet feed line 513 feeds an outlet draw line 515 from which a demand device or user may draw heated fluid meeting some specified heat requirements. The destination of heated fluid from the solar energy capture element 503 may be determined according to certain pre-determined parameters (e.g. fluid of at least a certain temperature or relative temperature may be directed to the outlet draw line 515 and heat of a certain temperature or relative temperature may be directed to the intermediate storage tank 509) and thus an outlet regulator 517 regulates the output of the solar energy capture element or panel 503. A fluid supply feed 519 is provided to the intermediate storage tank 509. Typically the flow of fluid is driven through the system by a fluid pump 521 associated with the inlet feed line 511, which is optionally a variable speed or pulsed pump. The system 501 may therefore be utilized with various demand systems and may be micromanaged to maximize efficiency of the solar heat capture element or panel 503 according to the hot fluid demand requirements.

The system 501 is shown in FIG. 2 as a solar water heating system in a solar water heating arrangement 523 useful for domestic, commercial or industrial purposes. According to this arrangement, the system 501 is incorporated into the heating arrangement by 523 by linking the outlet draw line 515 to feed into a hot water storage vessel 525 (such as a conventional domestic hot water storage cylinder) at a vessel inlet 527 positioned at an upper region of the vessel 525 for the supply of heated water reaching the pre-determined temperature threshold and the vessel 525 is linked via a vessel conduit 529 (typically positioned at a lower portion of the vessel 525) back to the solar water heating system 501 to form a second loop between the panel 503 and a hot water storage vessel 525. In use, the arrangement allows fluid flow around the second loop or around the first loop according to a set of pre-determined parameters, primarily the relative temperature of water at the solar energy capture element, the lower portion of the hot water storage vessel and the lower portion of the intermediate storage tank. The control of fluid flow is typically regulated by at least the fluid pump 521 and the outlet regulator 517 responsive to temperature sensors such as first temperature sensor 531 associated with the water at the top of the solar energy capture element 503 or at the element fluid outlet 507, second temperature sensor 533 associated with the water at the lower portion of the intermediate storage tank 509 and third temperature sensor 535 associated with water at the lower portion of the hot water storage vessel. The relationship between pumps and regulators and their performance relative the pre-determined parameters namely temperature sensor information is typically managed by a controller 539 in signal communication with each of the sensors and the pumps and regulators.

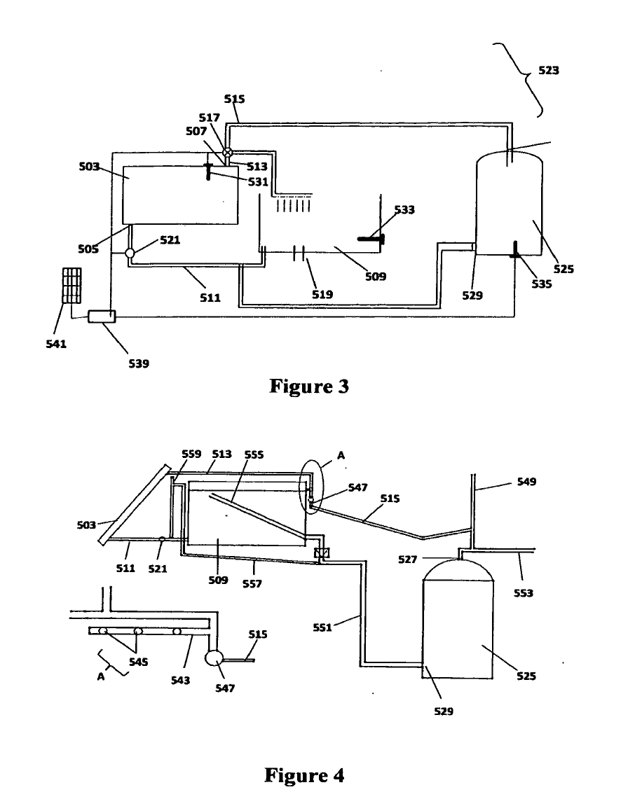

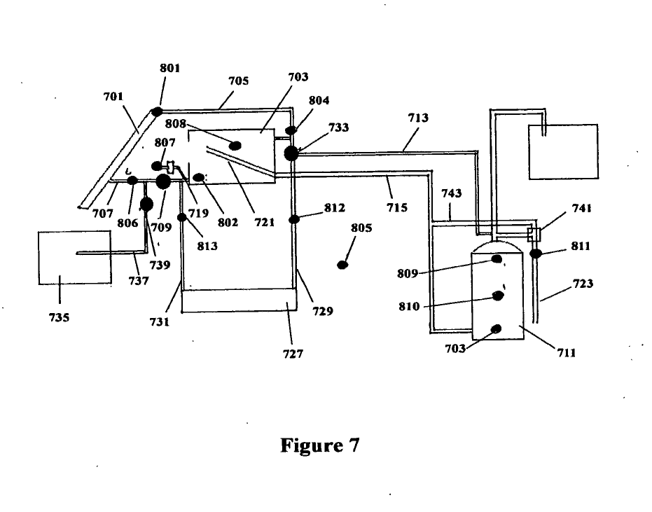

An optional control system shown in FIG. 3 for a solar fluid heating system 501 optionally forming part of a domestic solar water heating arrangement 523 comprises the controller 539 in signal communication with at least a variable speed fluid pump 521 for pumping fluid from the intermediary storage tank 509 or hot water storage vessel 525 to a solar energy capture element 503 and with at least a first temperature sensor 531, the controller 539 controlling the pump speed according to a feedback algorithm based on a feedback signal from the first temperature sensor 531, whereby as the temperature at the first temperature sensor 531 increases above a pre-determined threshold, for example 60° C., the speed of the pump 521 is increased by the controller 539. In this way, according to a preferred embodiment the panel pump 521 pumps at a fixed speed (e.g. by pulsed or low-speed pumping) until the temperature at the first temperature sensor 531 reaches the pre-determined level, above which the pump 521 pumps flat out (on-off-on-off, dependent upon whether the intermediate tank 509 is hotter than the panel 503. The feedback signal from temperature sensor 531 (and optionally a further sensor upstream of valve 517, e.g. 804 in FIG. 7) determines whether the flows from the element 503 are to the intermediate tank 509 or the hot water storage vessel 525.

In an alternative embodiment, the feedback signal from temperature sensor 531 may be used as a direct and instantaneous basis for the controller 539 to control outlet regulator 517 and thus the destination of heated fluid (e.g. the demand requirement or to the intermediate storage tank 509 (slave tank). The controller 539 may also be in signal communication with a solar intensity sensor 541 (which may be a solar PV panel and the measured signal may be the power generated to charge a battery to power the pump), a second temperature sensor 533 in the intermediate storage tank and optionally a third temperature sensor 535 in an associated hot water storage vessel 525 each providing signals for moderating the pump speed response to the first temperature sensor 531 feedback signal. By way of example, when T₁ (the temperature at the first temperature sensor 531) is greater than T₃ (the temperature at the third temperature sensor 535), the controller 537 causes the pump 521 to pump faster to ensure that the temperature of water produces is as close to the target temperature as possible (in order to maximize the efficiency of the panel). The pump speed may be moderated by the temperature T₂ at the second temperature sensor 533 and the solar intensity sensor 541, which signals are lead signals, which may provide input if on a downward trend to reduce the flow rate to ensure the temperature T₁ remains at the target temperature. Increasingly complex algorithms may be utilized by the controller to maximize efficiency of the panel by making appropriate use of the intermediate storage tank.

In FIG. 4 an alternative and preferred solar water heating arrangement for a domestic hot water supply is shown. According to this embodiment, the vented and unpressurised system has a solar energy capture element 503 which comprises a high level vent (not shown) whereby it can operate at up to 100° C. and without pressurization, an outlet feed line 513 having a slight decline from the element fluid outlet then a drop toward the outlet regulator which is in the form of an intercept pump 547, the outlet feed line having a side arm 543 feeding into the intermediate storage tank 509 via multiple outlets 545 to minimize disturbance of heat stratification within the tank 509. The outlet feed line 513, as shown in FIG. 4A depicting detail A, is provided with an air/steam vent, which provides a vent for the outlet feed line 513, the tank 509 and the outlet draw line 515. When the water associated with the solar energy capture element outlet has reached a pre-determined temperature or incremental temperature, intercept pump 547 is actuated to draw the water in the outlet feed line 513 through the outlet draw line 515, which is preferably a microbore pipe (of 10 mm diameter), to the vessel inlet 527 of hot water storage vessel 525 (e.g. domestic hot water cylinder). Preferably the outlet draw line 515 falls toward the hot water storage vessel 525 (assuming the latter is at a lower location than the former), but is provided with a slight rise before intersecting with a steam vent 549 for the hot water storage vessel 525 which provides the heated water at low flow rate with direct access to the vessel inlet 527. The fall and rise in outlet draw line 515 prevents hot water from the hot water storage vessel 525 passing back up toward the intermediate storage tank 509 and the solar energy capture element 503. Hot water on demand by a user may be typically drawn from the hot water storage vessel 525 via demand outlet 553. Large volume demand may be replenished directly from the intermediate storage tank 509. To achieve this, a vessel supply feed line 551 leads from the intermediate storage tank 509 to the vessel conduit 529 located in a lower portion of the vessel 525 for receipt of relatively cooler water. A variable level fluid outlet 555, typically having a buoyant portion to ensure it is in the upper portion of stored water, may be used to supply the vessel supply feed line with the warmest available water in the intermediate storage tank 509. When hot water directly from the panel element 503 is supplied to the hot water storage vessel 525 via outlet draw line 515, cooler water from the lower portion of the vessel 525 is drawn back to the solar water heating system, typically via vessel supply feed line 551. Optionally, instead of feeding water back into the intermediate storage tank 509, it may bypass the tank, e.g. by providing a microbore branch 557 and a one way valve on the vessel supply feed line leading to the inlet feed line 511. Preferably, the microbore branch 557 is also provided with a vent 559 to prevent air locks and this also results in the quantity flowing to and from the hot water storage vessel 525 and the solar heat capture element 503 being identical. As with the systems described above, the mains supply (not shown) is provided to the intermediate storage tank 509 and preferably no mains cold water supply is provided directly to the hot water storage vessel. The relative movements of water are preferably controlled by a controller (not shown) configured for signal communication with a number of temperature sensors, pumps and regulators as previously described.

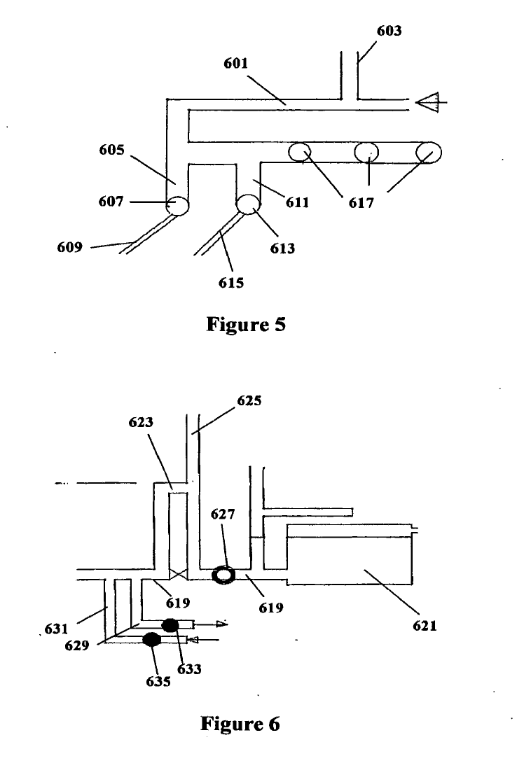

In FIG. 5, an alternative arrangement for the feeding of fluid from an outlet feed line to the intermediate tank or outlet draw line(s) is shown. According to this embodiment, an outlet feed line 601 is fed from the element outlet of the solar heat capture element (not shown), preferably on a slight decline. A vent 603 is provided to improve hydraulic flow in the remaining outlet feed line 601, which outlet feed line 601 leads to a first outlet sump 605 provided with a cylinder pump 607 feeding into a first outlet draw line 609 to a hot water storage cylinder. When the temperature of fluid in the first outlet sump 605 reaches a pre-determined temperature (e.g. 5° C. warmer than the temperature at the lower part of the hot water storage cylinder), the cylinder pump 607 is actuated. The cylinder pump 607 should preferably be sized larger than the pump feeding the solar energy capture element (not shown) so that when the temperature requirement is met, all the water is drawn off to the hot water storage cylinder (not shown). If pump 607 is not actuated, water is diverted to a second outlet sump 611 provided with a CH pump 613 feeding into a second outlet draw line 615 forming part of a space heating circuit (not shown), which CH pump is actuated when the water in the second outlet sump 611 reaches a pre-determined temperature (e.g. 5° C. warmer than a room thermostat temperature of a room to be heated). Should neither the cylinder pump nor the CH pump be actuated, fluid is fed via the outlet feed line to the intermediate storage tank (not shown) via multiple tank inlets 617. Typically, there are no pumps associated with the tank inlets which are fed via hydraulic flow from the solar energy capture element, and which multiple inlets 617 help maintain heat stratification in the intermediate storage tank.

FIG. 6 illustrates an embodiment of the invention in which the solar energy capture element is provided with hydraulic flow of fluid and in which a frost tank is provided. In this embodiment, an inlet feed line 619 between an intermediate tank 621 and a solar panel (not shown) is provided with an elevated flow path 623 and an associated vent 625. A pump 627 is provided which pumps fluid from the intermediate tank 621 to the height of the elevated flow path 623, to provide sufficient hydraulic head to feed the fluid into the solar panel and about the circuit to the intermediate storage tank 621. There is also provided feeding from the inlet feed line 619 (downstream from the elevated flow path 623) frost tank inlet 629 and frost tank outlet 631 fitted with respective temperature-actuated pumps 633, 635 which leads to a frost tank (not shown). When temperature in the solar panel falls below a pre-determined temperature (e.g. 3° C.), water is pumped to the frost tank. When temperature in the solar panel rises above a pre-determined temperature, water is pumped from the frost tank back to the panel.

FIG. 7 illustrates a system and arrangement for the solar heating of water for domestic hot water and space heating system and efficient heat management thereof. In FIG. 7, a solar heat capture element 701 forms a first fluid circulation loop with an intermediate storage tank 703 via outlet feed line 705 and inlet feed line 707, through which water is pumped by inlet pump 709. A second fluid circulation loop is formed between the solar heat capture element 701 and hot water storage cylinder 711 via outlet feed line 705, outlet draw line 713, vessel supply feed line 715 and inlet feed line 707. A third fluid transfer loop is formed by a fluid supply feed 719 (e.g. from a mains supply) into the intermediate storage tank 703 and via buoyant outlet arm 721 and vessel supply feedline to hot water cylinder 711 and outlet draw line 723. A fourth optional fluid circulation loop is a space heating circuit, comprising a radiation element 727 linked to outlet feedline 705 by radiator inlet 729 and to inlet feedline 707 via radiator outlet 731. The flow of fluid, for effective capture of heat and management of heated fluid, through the first, second and third, and optionally fourth, fluid circulation loops is achieved by controlling fluid inlet pump 709, outlet pump(s) 733. Preferably, a controller (not shown) controls the pumps 709, 733 according to actual or relative temperatures at a number of temperature sensors, typically comprising: sensor 801, a temperature sensor associated with the outlet of the solar heat capture element; 802, a temperature sensor associated with the lower portion of the intermediate tank; and 803, a temperature sensor associated with the lower portion of the heated water storage vessel; and optionally 804, a temperature sensor associated with the junction of the first and second fluid flow loops (downstream of the solar heat capture element); 805, a temperature sensor associated with a room to be heated by an optional central heating circuit; 806, a temperature sensor associated with a fluid inlet to the solar heat capture element 807, a temperature sensor associated with fluid supply inlet to the intermediate storage tank (e.g. mains water supply); 808, a temperature sensor associated with an upper portion of the intermediate storage tank; 809, a temperature sensor associated with an upper portion of a heated fluid storage vessel; 810, a temperature sensor associated with a mid-portion of a heated fluid storage vessel; 811, a temperature sensor associated with the demand draw outlet; 812, a temperature sensor associated with a space heating circuit outlet; and 813, a temperature sensor associated with a space heating circuit inlet. Accordingly, suitable flow control processes can be established according to pre-selected (and optionally variable) criterion based on respective temperatures at the temperature sensors can be applied in order to maximize efficiencies. Preferably, the principles applied are that small amounts of hot water are best transferred frequently via the second heat loop, whilst larger volumes of partially heated water may be captured in the intermediate storage tank for feeding into the panel to supply hot water or for replenishing hot water from the cylinder 711 on demand. The solar heat capture element 701 may also link to frost tank 735 fed by frost tank inlet/outlet 737 via frost pump(s) 739 which are temperature actuated.

A preferred feature is shown in FIG. 7 in which the demand draw line 723 may be mixed at mixer 741 with fluid from the intermediate storage tank 703 (which is typically partially warmed as compared with mains water) via branch line 743. Accordingly, minimal very hot water may be required to supply a fixed volume of water that is cooler than that in the host water storage vessel 711 (as compared with mixing with cold mains water). This feature, independently, also forms a further aspect of the invention for use with any of the embodiments described herein, as appropriate.

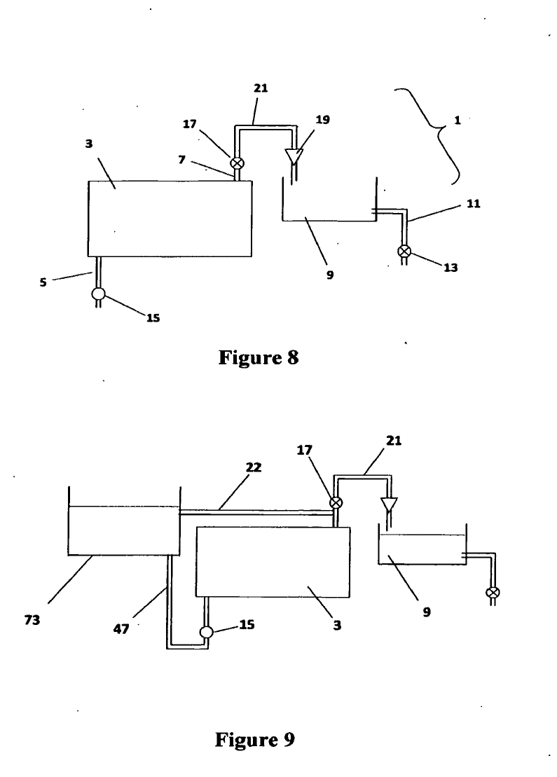

In FIG. 8, a continuous fluid pasteurization apparatus 1 for pasteurizing a fluid comprises a solar energy capture element (or assembly) 3, preferably in the form of a solar panel element, feeds fluid (e.g. water) to be pasteurized via fluid inlet 5 and delivering pasteurized fluid to outlet storage tank 9 via fluid outlet 7. Pasteurised fluid stored in fluid outlet tank 9 may be drawn via draw pipe 11 by actuating tap or draw valve 13. Fluid may be driven through the system 1 and in particular the panel element 3 by pressure produced from dissolution of dissolved air, head of water at the fluid inlet 5 or by actuating an inlet pump 15. Fluid may only be allowed to pass the fluid outlet 7 if the temperature of the fluid has reached or surpassed a pre-set pasteurization temperature (e.g. 72° C.) as measured by outlet regulator 17. The outlet regulator 17 typically comprises a temperature sensor and a temperature-responsive valve such that the valve is triggered to open when the temperature reaches the threshold pasteurization temperature. Inlet pump 15 may be set to maintain a pressure sufficient to drive fluid through the system at a particular rate when a valve at regulator 17 is open, or the system may operate at substantially zero pressure (i.e. the pressure at inlet pump 15 being at or within 10% of the head of water between regulator 17 and inlet pump 15) in which case it is preferable that inlet pump 15 is in signal communication with outlet regulator 17 such that the pump 15 will be actuated with the outlet regulator 17 signals the pasteurization temperature has been reached. This arrangement, i.e. the outlet regulator 17 comprising a temperature sensor in signal communication with inlet pump 15 may negate the need for a valve as part of outlet regulator 17. However, a valve as part of the regulator is preferred. Filter means 19 may be provided in the outlet fluid line 21 to remove unwanted particulates and discoloration.

FIG. 9 shows a preferred two tank arrangement in a system 1 corresponding to FIG. 8, in which a pasteurized fluid storage tank 9 is provided separately from inlet storage tank 73, which inlet storage tank also acts as an intermediate storage tank or slave tank. The continuous pasteurization system 101 of FIG. 6 comprises a solar energy capture element 3 having a fluid inlet 5 fed from a lower portion of intermediate storage tank 73 via inlet feed line 47, driven by variable speed inlet pump 15. When the fluid within the panel element 3 reaches a pre-determined pasteurization temperature (e.g. 72° C.), an outlet regulator 17 allows the passage of the fluid via pasteurized fluid line 21 to a pasteurized fluid storage tank 9. When the intensity of the sun is insufficient (e.g. in the morning or late evening) to heat to the pasteurization temperature, or if the pateurisation storage tank is full, fluid may be circulated through intermediate feed line 22 to the top of the intermediate storage tank 73. Preferably, the variable speed inlet pump 15 is responsive to the intensity of the sunlight and the temperature at the outlet regulator 17 and more preferably utilizes a solar PV panel (not shown) for its power.

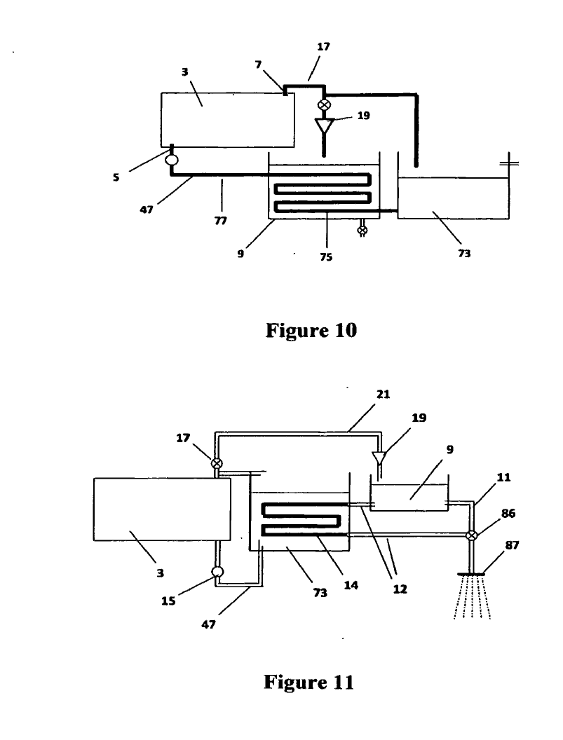

In FIG. 10, a two-tank system comprising a solar energy capture element 3 having a fluid outlet 7 leading to pasteurized fluid storage tank 9 via outlet regulator 17 and filter means 19 may be used, in applications (such as pasteurization for drinking water) not requiring heated water, in re-capturing heat from the pasteurized fluid thus making the pasteurization process more efficient by arranging the fluid inlet feed line 47 to pass from the intermediate storage tank 73 through the outlet storage tank 9 to the fluid inlet 5. The fluid inlet feed line 47 comprises a heat exchange portion 75 being the portion of the line placed within the outlet storage tank, which portion 75 should be formed of a thermally conductive material, such as copper tubing. The remainder of the fluid inlet feed line 47 is the fluid transfer portion 77 which should be formed of thermally insulating material to retain the heat re-captured. In an alternative configuration, the heat transfer may be carried out by causing the pasteurized fluid feed line 21 to pass through the intermediate fluid storage tank 73 to transfer heat from the pasteurized fluid to the unpasteurized fluid prior to being supplied to pasteurized fluid storage tank 9.

FIG. 11 shows an embodiment of the invention requiring the production of pasteurized and heated water for showering. A pasteurization system is shown corresponding to that in FIG. 8 described above in which water for pasteurization is provided to intermediate storage tank 73 and fed via inlet feed line 47 under the control of inlet pump 15 to solar heat capture element 3. Once a pasteurization temperature is reached according to the regulator 17, fluid is allowed to pass outlet feed line 21 through a filter 19 to a pasteurized water storage tank 9. Optionally, a side arm may be provided to extend from the element fluid outlet to return water not at the pasteurization temperature to the intermediate storage tank. A draw pipe 11 from the pasteurized water storage tank 9 leads via a thermostatic valve 86 to a shower head 87. The thermostatic valve 86 may also be served by a second draw pipe 12 emanating from the pasteurized water storage tank 9 via a heat exchange coil 14 located within the intermediate storage tank 73 to provide a second source of, typically, relatively cool water for the thermostatic valve 86.

An embodiment adapted from that of FIG. 11 may be utilized according to one embodiment for the production of pasteurized water for drinking. According to this embodiment, FIG. 11 is adapted by substituting shower head 87 with a standard fluid outlet (e.g. tap) and removing draw pipe 11, relying solely on second draw pipe 12. By sizing pasteurized water storage tank 9 for 2 hours of water, the risk of bacterial cysts making it into drinking water can be greatly reduced, whilst re-capturing the heat of pasteurized fluid for re-use (and supplying cooled water for the user).

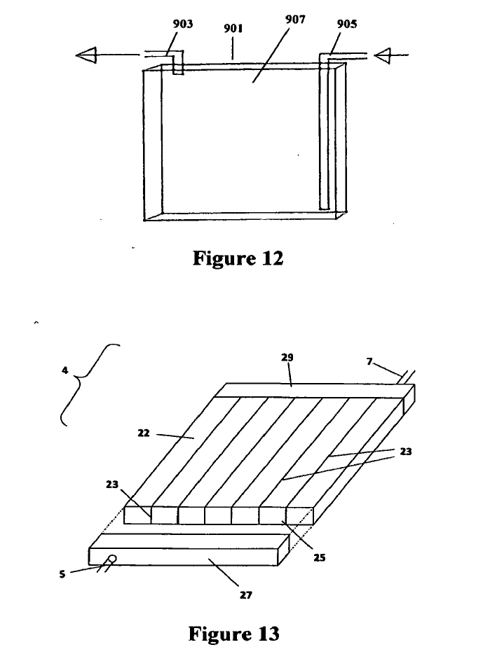

FIG. 12 illustrates a solar energy capture element 901 having an element outlet 903 and longitudinally extended fluid inlet 905. Element 901 is preferably a sealed double glazed unit, which comprises a first glazed surface 907 and opposing rear glazed surface which is preferably pigmented.

FIG. 13 illustrates a solar energy capture element 3 (or 503) in accordance with one embodiment of the invention. A solar energy capture element 3 (or 503) may be a panel element 4, which may be formed of a low-cost insulating material such as polycarbonate, having a fluid inlet 5 and a fluid outlet 7 may comprise an internal volume defined by a series of dividing elements 23 between a first, radiation receiving, sheet 22 (which should be substantially translucent to solar radiation) and a second sheet (forming the back of the panel; not shown), defining of a plurality of parallel conduits 25 leading from an inlet manifold 27 to an outlet manifold 29 each defining a conduit substantially perpendicular to the series of parallel conduits 25. The inlet and outlet manifolds 27,29 may clip onto the dividing elements and optionally be sealed thereto. By this arrangement, multiple routes from fluid inlet 5 to fluid outlet 7 are available, each of which is the same distance thus reducing the pressure required to drive fluid through the system and reducing the risk of problems caused by blockage. The fluid outlet 7 is typically associated with a vent (not shown) to allow the panel element 4 to operate at a maximum of about 100° C. (appropriate for the use of polycarbonate as the material). Alternatively, the fluid outlet 7 may be configured to be lower than the top of the panel element 4, and the panel element 4 provided with a steam vent (not shown) at the apex of the panel.

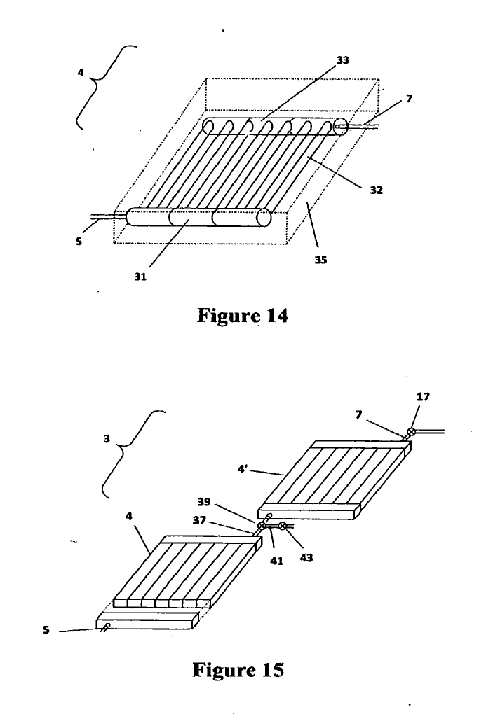

An alternative arrangement of a solar panel element 4 is shown in FIG. 14 in which fluid inlet 5 leads to inlet manifold pipe 31 connected to a plurality of parallel pipes 32 leading to outlet manifold pipe 33 and then to fluid outlet 7, each of which pipes may be formed of transparent insulating material for capturing solar radiation but preferably thermally conductive material such as copper. In the latter case, the element 4 is formed in a solar panel casing 35, which should be made of a thermally insulating material capable of allowing the passage of the solar radiation into the casing itself. A solar radiation absorbing material may be coated onto the surface of the pipes to aid conversion of solar radiation to heat (e.g. using a black paint) or placed elsewhere within the casing 35. Preferably, the panel element 4 is vented to atmosphere thereby allowing unpressurised operation and a maximum temperature of about 100° C.

In FIG. 15, a solar energy capture assembly 2 is formed of two modular panel elements 4, of the type shown in FIG. 14, arranged in series and together having a fluid inlet 5 and a fluid outlet 7 and connected together between the first module outlet and second module inlet by first interconnector 37, typically formed of a flexible pipe. The first interconnector 37 may optionally comprise a interconnector valve or regulator 39 and optionally an interconnector side outlet 41, which itself may be configured with a side outlet regulator 43. An interconnector valve 39 may be used as a regulator to allow passage of fluid to the second modular panel element 4′ when the fluid reaches a pre-determined temperature. Alternatively, interconnector valve 39 may be used as a three-way selection valve whereby fluid may be selected to flow from panel element 4 to panel element 4′ through interconnector 37 or from panel element 4 to interconnector side outlet 41 or both. By this means, the system may be adapted according to the size of panel needed (e.g. for seasonal weather conditions, utilising a smaller panel assembly for summer and a larger panel assembly for spring and autumn, or according to demand for pasteurized fluid). Accordingly, side outlet regulator 43 may be configured to operate like outlet regulator 17 by allowing the passage of fluid when it reaches a pre-determined pasteurization temperature. In another embodiment of this modular panel configuration, interconnector valve 39 may be selected to allow passage through of fluid to panel 4′ and to interconnector side outlet 41 and both of outlet regulator 17 and side outlet regulator 43 configured to allow the passage of fluid when a (the same) pre-determined pasteurization temperature is reached whereby in very hot weather the pasteurization fluid production rate may be increased (provided there is sufficient pumping capacity to the fluid inlet). Typically the interconnector side outlet may be fed to outlet storage tank (not shown).

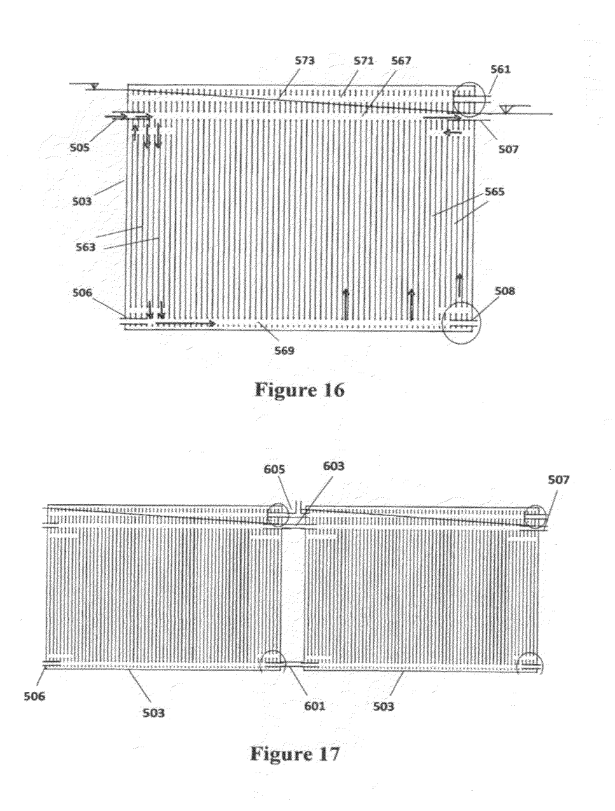

In FIG. 16, a preferred solar energy capture panel arrangement is illustrated in plan. According to FIG. 16, a solar energy capture element 503, which is preferably manufactured from an extrudable heat insulating solar radiation translucent material such as polycarbonate, has a fluid inlet 505 or uses an alternative fluid inlet 506 for high or low level fluid addition, a fluid outlet 507 and an optional steam or air vent 561 at or near the top of the panel. A series of divider elements 563 define a plurality of longitudinal channels or conduits 565 running from bottom to top. A first cross-conduit 567 is formed in an upper portion of the element 503 to connect the longitudinal channels 565 to the fluid outlet 507. A second cross-conduit 569 is formed at a lower portion of the element 503 to connect the longitudinal channels 565 together at a low level to allow the distribution of water fed into the element 503 by one of the inlets 505 or 506. A third cross-conduit 571 links all the longitudinal channels at an upper portion to the optional steam/air vent 561. In the absence of a steam/air vent, the outlet 561 may act as fluid outlet. The interlinked plurality of longitudinal channels 565 allow stratification of heat (and avoid turbulence by fluid being pumped into the element) and for hot water to accumulate at the upper portion of the element 503. Preferably, if the fluid outlet 507 is unimpeded (i.e. allows the passage of fluid to an outlet feed line (not shown), the upper level of fluid in the element 503 will be at the fluid outlet 507 when static. A temperature sensor (not shown) will be preferably located in the element 503 at or about the fluid outlet, which sensor can provide a signal for controlling an inlet pump (not shown) responsible for pumping fluid into the element 503. When the inlet pump is actuated, the fluid level will rise and a hydraulic gradient 573 will form and the level of fluid at the outlet will reach the upper portion of the fluid outlet and fluid will flow through the element 503. A drain outlet 508 may be sued as an alternative means to drain the system in case of frost or for maintenance, or for interconnecting several panels together in series to operate effectively in parallel.

As shown in FIG. 17, a plurality of solar energy capture elements 503 can be operated in parallel to provide, in effect, a larger panel by modular addition. FIG. 17 illustrates a solar energy capture assembly 575 comprising two solar energy capture elements 503 connected side by side. The two panel elements are linked via low level connector 601 which connects the drain outlet 508 of a first element to a low level fluid inlet 506 of a second panel element, a high level connector 603 linking a fluid outlet 507 of a first element with a high level fluid inlet 505 of a second element and steam vent connector 605 which links a steam vent 561 of a first panel with a connector inlet of a second panel. Optionally the steam vent connector 605 vents to atmosphere and alternatively vents to atmosphere without connecting to the second element. Fluid will be pumped into the system through, for example, inlet 506 and optionally a further pump can be provided in connector 603 and heated fluid collected via common fluid outlet 507.

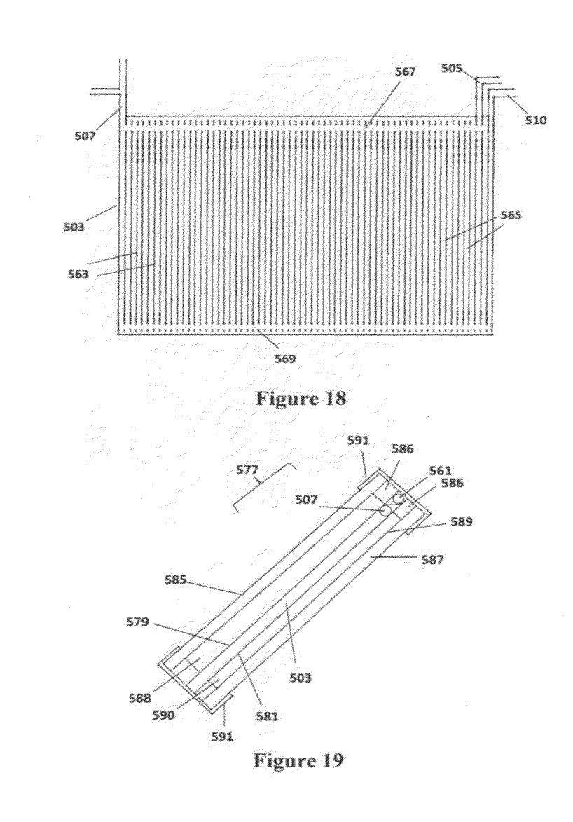

FIG. 18 shows a preferred solar energy capture element arrangement. According to FIG. 18, a solar energy capture element 503 which is preferably manufactured from an extrudable heat insulating solar radiation translucent material such as polycarbonate, has a fluid inlet 505 for high level fluid addition and a fluid outlet 507. An optional steam or air vent 562 may be provided associated with the fluid outlet 507 at the hydraulic apex. A series of divider elements 563 define a plurality of longitudinal channels or conduits 565 running from bottom to top. A first cross-conduit 567 is formed in an upper portion of the element 503 to connect the longitudinal channels 565 to the fluid outlet 507. A second cross-conduit 569 is formed at a lower portion of the element 503 to connect the longitudinal channels 565 together at a low level to allow the distribution of water fed into the element 503 by inlet 505. The interlinked plurality of longitudinal channels 565 allow stratification of heat (and avoid turbulence by fluid being pumped into the element) and for hot water to accumulate at the upper portion of the element 503. Preferably, if the fluid outlet 507 is unimpeded (i.e. allows the passage of fluid to an outlet feed line (not shown), the upper level of fluid in the element 503 will be at the fluid outlet 507 when static. A temperature sensor (not shown) will be preferably located in the element 503 at or about the fluid outlet, which sensor can provide a signal for controlling an inlet pump (not shown) responsible for pumping fluid into the element 503. When the inlet pump is actuated, the fluid level will rise and fluid will flow through the element 503. A drain outlet 510 may be used to drain the system in case of frost or for maintenance.

FIG. 19 shows a preferred solar panel 577 in accordance with the invention comprising a solar energy capture element 503 (or 3) as defined herein and being adapted from twin wall 10 mm polycarbonate sheet, preferably having a front solar radiation receiving surface 579 of polycarbonate translucent to solar radiation to allow water in the element 503 to absorb incident radiation and a back surface 581 coloured black for broad spectrum absorption and heating for transfer of heat to the water. Preferably the back surface 581 is silvered on the rear of the surface. The panel 577 further comprises on the radiation receiving face a translucent radiation receiving insulating sheet 585, preferably a 10 mm twin walled polycarbonate sheet, for allowing the passage of light whilst helping to maintain heat retention within the panel. The translucent insulating sheet 585 is separated (e.g. by an amount of 16 mm) from the element 503 by a separator 586 to form an air gap 588. On the rear of the panel 577 is provided a foamed polyurethane insulating sheet 587 having a silvered inner surface 589, the insulating sheet 587 separated by a separator 586 to form an air gap 590. The polyurethane insulating sheet 587 is pliable and may be moulded to a roof profile and thus capable of use on various roof surfaces. The element 503 and the insulating sheets 585 and 587 are clamped together with a pre-tensioned aluminium frame 591 which allows some relative movement of the individual sheets to account for varying thermal expansions. The Figure shows the fluid outlet 507 and optional panel steam vent 561.

The invention has been described with reference to preferred embodiments. However, it will be appreciated that variations and modifications can be effected by a person of ordinary skill in the art without departing from the scope of the invention.

1. A solar water heating arrangement comprising a hot water storage vessel having a heat insulated internal volume for storage of hot water for use by a user and linked thereto a solar water heating system comprising
a solar energy capture element having an internal volume for containing water to be heated, an element fluid inlet and an element fluid outlet;
an intermediate fluid storage tank configured for fluid communication with the element fluid inlet and the element fluid outlet of the solar heat capture element;
a water supply feed to the intermediate storage tank;
an inlet feed line for providing water to the element fluid inlet of the solar energy capture element from the intermediate fluid storage tank;
an outlet feed line for feeding water from the element fluid outlet of the solar energy capture element to the intermediate fluid storage tank and to an outlet draw line through which heated water may be drawn; and
an outlet regulator associated with the outlet draw line, said outlet regulator being responsive to temperature whereby water may pass the outlet from the solar energy capture element through the outlet draw line when a desired temperature or relative temperature of water at the outlet draw line is reached,
wherein the arrangement further comprises a demand outlet for the drawing of water from the hot water storage vessel by the user, a vessel inlet for receiving solar heated water at the hot water storage vessel from the outlet draw line of the solar water heating system, and a vessel conduit for transfer of water from the hot water storage vessel to the solar water heating system, the solar water heating arrangement configured such that, in use, when the temperature of water in the hot water storage vessel is lower than or a predetermined increment lower than the temperature at or associated with the outlet regulator of the solar water heating system, water from the outlet feed line will be fed into the hot water storage vessel via the vessel inlet and water from the hot water storage vessel will be fed via the vessel conduit to the solar water heating system.

2. A solar water heating arrangement as claimed in claim 1, which further comprises at least one fluid pump for circulating fluid through the solar energy capture element and the intermediate fluid storage tank and optionally at least one further fluid pump for propulsion of fluid into the outlet draw line when the outlet regulator allows.

3. A solar water heating arrangement as claimed in claim 1 or claim 2, which further comprises a first temperature sensor associated with fluid in the element, at the element fluid outlet or in the outlet feed line and a second temperature sensor associated with fluid in the intermediate tank or in the inlet feed line, whereby passage of fluid from the solar heat capture element and the intermediate tank may be regulated according to the relative temperatures or an incremental temperature between the first and second temperature sensors.

4. A solar water heating arrangement as claimed in any one of claims 1 to 3, which further comprises a controller for controlling any regulators or pumps responsive to any temperature sensors.

5. A solar water heating arrangement as claimed in any one of claims 1 to 4, wherein the demand outlet and vessel inlet are at an upper portion of the hot water storage vessel and the vessel conduit is at a lower portion of the hot water storage vessel, whereby water drawn by a user from the demand outlet of the hot water storage vessel is drawn from a portion of water in the tank that is relatively hot due to heat stratification of water in the vessel and water transferred from the hot water storage vessel to the solar water heating system via the vessel conduit is the relatively cool water in the vessel due to heat stratification in the vessel.

6. A solar water heating arrangement as claimed in any one of the preceding claims, wherein a temperature sensor is provided in a lower portion of the hot water storage vessel for use in the determination of the temperature of water in the hot water storage vessel relative to the temperature of water at outlet regulator of the solar water heating system.

7. A solar water heating arrangement as claimed in any one of the preceding claims, which further comprises a vessel supply inlet for replenishing the volume of water in the hot water storage vessel that is drawn by a user from the demand outlet, the vessel supply inlet being fed by a vessel supply feed line from the intermediate tank of the solar water heating system.

8. A solar water heating arrangement as claimed in claim 7, wherein a mains supply of water is provided to the solar water heating arrangement via a mains feed to the intermediate tank.

9. A solar water heating arrangement as claimed in claim 7 or claim 8, wherein the vessel supply inlet is the vessel conduit.

10. A solar water heating arrangement as claimed in any one of claims 7 to 9, wherein the vessel supply feed line from the intermediate tank of the solar water heating system is configured to draw water from the upper portion of water in the intermediate tank.

11. A solar water heating arrangement as claimed in claim 10, wherein the vessel supply feed line comprises an intermediate storage tank fluid outlet having a flexible portion and a buoyant portion whereby the fluid outlet is configured to be located in the upper portion of water in the intermediate storage tank.

12. A solar water heating arrangement as claimed in any one of the preceding claims, wherein the hot water storage vessel is provided with a further water heating system, optionally selected from a water heating circuit with a conventional boiler, a heat exchange loop provided within the hot water storage vessel from a further heat source or an emersion heater.

13. A solar water heating arrangement as claimed in any one of the preceding claims, wherein the hot water storage vessel is a domestic unpressurised hot water cylinder.

14. A solar water heating arrangement as claimed in any one of the preceding claims, wherein the solar water heating system is vented to atmosphere at an upper portion of the system or at an upper portion of the solar heat capture element, whereby the vapour or steam may escape to avoid a build up of pressure in the system and whereby the maximum operating temperature of the system is limited to about the liquid-vapour transition temperature of the fluid.

15. A method for the capture, control, management and/or storage of heat in water from a solar heat capture element, the method comprising
providing a solar heat capture element, a hot water storage vessel from which heated water may be drawn and an intermediate storage tank provided with an inlet supply of fluid;
providing at least two fluid circulation loops, a first fluid circulation loop configured for fluid to flow from the solar heat capture element to the intermediate storage tank and back to the solar heat capture element and a second fluid circulation loop configured for flow from the solar heat capture element to the hot water storage vessel and back to the solar heat capture element; and
causing the fluid to flow about the first and/or second fluid circulation loops according to certain criteria, preferably for optimum heat capture and/or storage efficiency.

16. A method as claimed in claim 15 which further comprises a third fluid loop comprising the inlet supply of fluid, the intermediate storage tank, the hot water storage vessel, a demand draw outlet for drawing fluid from the water storage vessel on demand, and a fluid conduit connecting the intermediates storage tank and the hot water storage vessel, whereby hot water drawn from the hot water storage vessel may be replenished from the intermediate storage tank.

17. A method as claimed in claim 15 or claim 16, wherein the respective flow of water about the first and second fluid flow loops is dependent upon the respective temperatures or relative temperatures of water in each of one or more locations within the solar energy capture element, hot water storage vessel and intermediate fluid storage and/or in one or more of the fluid conduits at pre-determined locations therebetween.

18. A solar fluid heating system comprising
a solar energy capture element having an internal volume for containing a fluid to be heated, an element fluid inlet and an element fluid outlet;
an intermediate fluid storage tank configured for fluid communication with the element fluid inlet and the element fluid outlet of the solar heat capture element;
a fluid supply feed to the intermediate storage tank;
an inlet feed line for providing fluid to the element fluid inlet of the solar energy capture element from the intermediate fluid storage tank;
an outlet feed line for feeding fluid from the element fluid outlet of the solar energy capture element to the intermediate fluid storage tank and to an outlet draw line through which heated fluid may be drawn; and
an outlet regulator associated with the outlet draw line, said outlet regulator being responsive to temperature whereby fluid may pass the outlet from the solar energy capture element through the outlet draw line when a desired temperature or relative temperature of fluid at the outlet draw line is reached.

19. A solar fluid heating system as claimed in claim 18, which further comprises a fluid pump for circulating fluid through the solar energy capture element and the intermediate fluid storage tank and/or for propulsion of fluid into the outlet draw line when the outlet regulator allows.

20. A solar fluid heating system as claimed in claim 18 or claim 19, which further comprises a first temperature sensor associated with fluid in the element, at the element fluid outlet or in the outlet feed line and a second temperature sensor associated with fluid in the intermediate tank or in the inlet feed line, whereby passage of fluid from the solar heat capture element and the intermediate tank may be regulated according to the relative temperatures or an incremental temperature between the first and second temperature sensors.

21. A solar fluid heating system as claimed in any one of claims 18 to 20, which further comprises a controller for controlling any regulators or pumps responsive to any temperature sensors.

22. A solar water heating system comprising a solar fluid heating system as claimed in any one of claims 18 to 21 in which the fluid is water.

23. A solar fluid heating system or solar water heating system as claimed in any one of claims 18 to 22, wherein the solar fluid heating system or solar water heating system is vented to atmosphere at an upper portion of the system or at an upper portion of the solar heat capture element, whereby the vapour or steam may escape to avoid a build up of pressure in the system and whereby the maximum operating temperature of the system is limited to about the liquid-vapour transition temperature of the fluid.

24. A solar fluid heating system or solar water heating system as claimed in any one of claims 18 to 22, wherein the solar fluid heating system or solar water heating system is operated as an unpressurised system.

25. A solar fluid heating arrangement for space heating, the arrangement comprising
a solar energy capture element having an internal volume for containing a fluid to be heated, an element fluid inlet and an element fluid outlet;
an intermediate fluid storage tank configured for fluid communication with the element fluid inlet and the element fluid outlet of the solar heat capture element;
an inlet feed line for providing fluid to the element fluid inlet of the solar energy, capture element from the intermediate fluid storage tank;
an outlet feed line for feeding fluid from the element fluid outlet of the solar energy capture element to the intermediate fluid storage tank; and
coupled with the intermediate fluid storage tank a fluid-carrying space heating circuit the arrangement configured such that when the temperature of the fluid in the intermediate fluid storage tank is greater than or is greater than by a predetermined increment the temperature of the space in which the space heating circuit is configured to heat, the fluid is caused to circulate through the space heating circuit thereby providing space heating.

26. A solar fluid heating arrangement as claimed in claim 25, wherein the circulation of fluid through the space heating circuit comprises circulation of fluid between the intermediate fluid storage tank and the space heating circuit.

27. A solar fluid heating arrangement as claimed in claim 25, wherein the fluid-carrying space heating circuit is coupled with the intermediate storage tank to utilize heat in the intermediate storage tank for space heating by way of a heat exchange coil located within the fluid contained in the intermediate fluid storage tank.

28. A solar water heating arrangement as claimed in any one of claims 1 to 14, which further comprises an arrangement for space heating as defined in any one of claims 25 to 27.

29. A continuous fluid pasteurization system comprising a solar fluid heating system as defined in any one of claims 18 to 24 and a pasteurized fluid feed line linked to the outlet draw line through which fluid may be drawn, wherein the outlet regulator allows fluid to pass the outlet draw line only when the fluid reaches or exceeds a pre-determined pasteurization temperature.

30. A continuous fluid pasteurization system as claimed in claim 29 which further comprises at least one pasteurized fluid holding tank served by the pasteurized fluid feed line.

31. A continuous fluid pasteurization system as claimed in claim 30, wherein the pasteurized feed line feeds fluid to the pasteurized fluid holding tank via a purification filter.

32. A continuous fluid pasteurization system as claimed in any one of claims 29 to 31, wherein the pasteurized fluid feed line or a holding tank draw line (for drawing pasteurized fluid from the pasteurized fluid holding tank) comprises a heat exchange element located within the intermediate fluid storage tank, whereby pasteurized fluid within the pasteurised fluid feed line or the holding tank draw line passes through the heat exchange element thereby allowing the transfer of heat from the pasteurized fluid to fluid within the intermediate fluid storage tank.

33. A continuous fluid pasteurization system as claimed in any one of claims 29 to 32, wherein the pasteurization temperature is selected in the range from 50° C. to 75° C.

34. A solar energy capture element for the capture of solar energy in a fluid to produce a fluid at a raised temperature, the element comprising
a front solar radiation receiving surface;
a back surface
an internal volume or fluid space between the front and back surfaces having a depth defined by the thickness of an edge;
two side edges;
an upper edge (upper being defined by its relative position in use)
a lower edge, the direction from the lower edge to the upper edge defining a longitudinal direction;
a plurality of longitudinal conduits arranged in a longitudinal direction
a first cross-conduit traversing the plurality of longitudinal conduits in an upper portion of the element
a second cross-conduit traversing the plurality of longitudinal conduits in a lower portion of the element,
a fluid inlet for receiving fluid to be heated into the element;
a fluid outlet for dispensing heated fluid from the element, the fluid outlet being positioned in an upper portion of the element; and, optionally,
a vapour vent to allow the release of air or fluid vapour, the vapour vent emanating from the element at a position in the upper edge or between the fluid outlet and the upper edge.

35. A solar energy capture element as claimed in claim 34, wherein the front solar radiation receiving surface is formed by a first solar radiation receiving sheet which is translucent to at least a part of the solar spectrum, the back surface is formed by a second sheet and the plurality of longitudinal conduits are defined by a plurality of longitudinally arranged divider elements.

36. A solar energy capture element as claimed in claim 34 or claim 35, wherein the front and back surfaces and the edges are formed of polycarbonate.

37. A solar energy capture element comprising a first polycarbonate sheet and a second polycarbonate defining therebetween an internal volume for containing a fluid to be heated, the internal volume having a fluid inlet, a fluid outlet and a plurality of longitudinal channels within the internal volume defined by plurality of divider elements, wherein the first polycarbonate sheet is translucent to solar radiation and the second polycarbonate sheet is coated or impregnated with a broad spectrum dye or pigment, such as carbon black, for absorbing solar energy.

38. A solar panel comprising
a planar solar energy capture element for capture of solar energy in a fluid in its internal volume, the planar solar energy capture element comprising a front solar radiation receiving surface;
a first layer of sheet insulation located in front of the front solar radiation receiving surface of the solar energy capture element, the first layer of sheet insulation being translucent to at least a portion of the solar radiation spectrum;
a second layer of sheet insulation located behind the solar energy capture element; and
a panel frame for holding the assembly of solar heat capture element and the first and second layers of insulation together, the panel element comprising a front gripping element and a rear gripping element configured to abut the front and rear of the assembly and to have applied between the front and rear gripping elements sufficient tension to hold the assembly in place, whereby it allows relative movement and thermal expansion of the solar heat capture element and the first and second layers of sheet insulation.

39. A solar panel as claimed in claim 38, wherein the solar heat capture element is as defined any one of claims 34 to 37.

40. A solar panel as claimed in claim 38 or claim 39, wherein the first layer of sheet insulation is a double-wall polycarbonate sheet.

41. A solar panel as claimed in any one of claims 38 to 40, wherein the second layer of sheet insulation is a polyurethane foam sheet.

42. A system or arrangement as claimed in any one of claims 1 to 14 and 18 to 24, wherein the solar energy capture element is as defined in any one of claims 34 to 37.

43. A system or arrangement as claimed in claim 42, wherein the solar energy capture element is formed as a panel as defined in any one of claims 38 to 41.
